(19) United States
(12) Patent Application Publication
(10) Pub. No.: US 2008/0065460 A1
(43) Pub. Date: Mar. 13, 2008

(54) Apparatus, system, method, and computer program for task and process management

(75) Inventor: Geoffrey Paul Raynor, Fort Worth, TX (US)

Correspondence Address: DOCKET CLERK, P.O. DRAWER 800889, DALLAS, TX, 75380, US

(73) Assignee: Renegade Swish, LLC, Fort Worth, TX (US)

(21) Appl. No.: 11/541,156

(22) Filed: Sep. 29, 2006

Related U.S. Application Data
(60) Provisional application No. 60/839,609, filed on Aug. 23, 2006.

(51) Int. Cl. G06F 15/02

(52) U.S. Cl. 705/9

(57) ABSTRACT

This disclosure provides an apparatus, system, method, and computer program for task and process management. Information identifying multiple steps associated with a task can be stored. First input, from one or more users, may indicate completion of at least one of: the task and each step associated with the task. Second input may represent a dialog between multiple ones of the users. A graphical display for presentation to the one or more users can be generated. The graphical display may identify at least some of the steps associated with the task. The graphical display may also identify a status of at least one of: the task and at least some of the steps associated with the task. The graphical display may further identify at least a portion of the dialog between the multiple users.

### CROSS-REFERENCE TO RELATED APPLICATIONS

This application claims priority under 35 U.S.C. § 119(e) to U.S. Provisional Patent Application No. 60/839,609 filed on Aug. 23, 2006, which is hereby incorporated by reference.

### TECHNICAL FIELD

This disclosure is generally directed to management systems. More specifically, this disclosure is directed to an apparatus, system, method, and computer program for task and process management.

### BACKGROUND

The management of various tasks and processes in any organization is often a difficult and time-consuming endeavor. For example, employees or other personnel in an organization are often engaged in or are responsible for performing multiple processes, each of which may include many different functions or tasks. Often times, the employees or other personnel must interact with one another to perform these processes and tasks. Moreover, managers or other upper-level personnel often must oversee the execution of the processes and tasks to ensure that the processes and tasks are assigned, performed, and completed correctly and in a timely manner.

### SUMMARY

This disclosure provides an apparatus, system, method, and computer program for task and process management.

In a first embodiment, an apparatus includes at least one memory operable to store information identifying multiple steps associated with a task. The apparatus also includes at least one processor operable to receive first input from one or more users indicating completion of at least one of: the task and each step associated with the task. The at least one processor is also operable to receive second input comprising a dialog between multiple ones of the users. The at least one processor is further operable to generate a graphical display for presentation to the one or more users. The graphical display identifies at least some of the steps associated with the task, a status of at least one of: the task and at least some of the steps associated with the task, and at least a portion of the dialog between the multiple users.

In particular embodiments, the dialog includes at least one comment associated with at least one of: the task and at least one of the steps associated with the task. The dialog also includes at least one response to the at least one comment.

In other particular embodiments, at least one of the users may associate the task with a status report, where the status report contains the dialog between the multiple users. Also, at least one of the users may specify which users are allowed to view and modify the status report. Further, at least one of the users may email the status report to at least one other of the users. In addition, at least one of the users may specify that the status report is subject to a confidentiality obligation.

In a second embodiment, a method includes receiving first input from one or more users indicating at least one of: completion of a task and completion of each of multiple steps associated with the task. The method also includes receiving second input comprising a dialog between multiple ones of the users. The method further includes generating a graphical display for presentation to the one or more users. The graphical display identifies at least some of the steps associated with the task, a status of at least one of: the task and at least some of the steps associated with the task, and at least a portion of the dialog between the multiple users.

In a third embodiment, a computer program is embodied on a computer readable medium and is operable to be executed by a processor. The computer program includes computer readable program code for receiving first input from one or more users indicating at least one of: completion of a task and completion of each of multiple steps associated with the task. The computer program also includes computer readable program code for receiving second input comprising a dialog between multiple ones of the users. In addition, the computer program includes computer readable program code for generating a graphical display for presentation to the one or more users. The graphical display identifies at least some of the steps associated with the task, a status of at least one of: the task and at least some of the steps associated with the task, and at least a portion of the dialog between the multiple users.

In a fourth embodiment, a system includes a database operable to store information identifying multiple steps associated with a task. The system also includes a server operable to receive first input from one or more users indicating completion of at least one of: the task and each step associated with the task. The server is also operable to receive second input comprising a dialog between multiple ones of the users. The server is further operable to generate a graphical display for presentation to the one or more users. The graphical display identifies at least some of the steps associated with the task, a status of at least one of: the task and at least some of the steps associated with the task, and at least a portion of the dialog between the multiple users. In addition, the system includes at least one user device operable to display the graphical display and provide the first and second inputs from the one or more users to the server.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system for task and process management in accordance with this disclosure;

FIGS. 2 through 58 illustrate an example graphical user interface for task and process management in accordance with this disclosure; and

FIGS. 59 through 63 illustrate example methods for task and process management in accordance with this disclosure.

### DETAILED DESCRIPTION

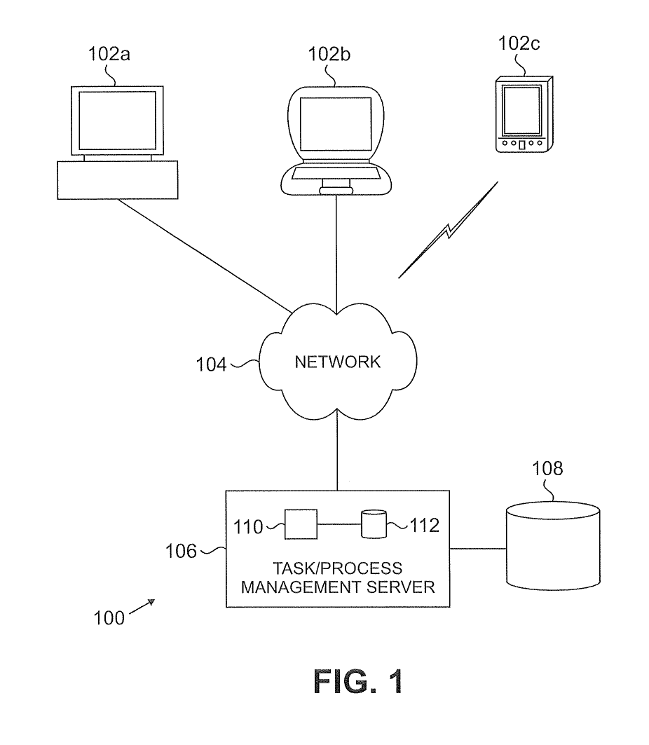

FIG. 1 illustrates an example system 100 for task and process management in accordance with this disclosure. In the illustrated example, the system 100 includes multiple user devices 102a-102c, a network 104, a task/process management server 106, and a database 108. This embodiment of the system 100 is for illustration only. Other embodiments of the system 100 may be used without departing from the scope of this disclosure.

In one aspect of operation, a user uses one of the user devices 102a-102c (referred to as “user devices 102”) to access the task/process management server 106. Among other things, the task/process management server 106 presents a graphical user interface to the user that allows the user to create, modify, delete, and manage various tasks or processes. For example, the user may create a task, assign the task to himself or herself or to anther user, view his or her tasks, and generate reports. The task/process management server 106 may also store information about the various processes and tasks in the database 108. In this way, the task/process management server 106 may facilitate the creation, management, and performance of processes and tasks by a wide variety of users.

In the illustrated embodiment, each user device 102 is capable of communicating with the network 104. Each user device 102 represents any suitable device, system, or portion thereof that allows a user to communicate and interact with the task/process management server 106. For example, a user device 102 may allow a user to access the task/process management server 106 and create or retrieve information associated with processes or tasks. In this example, the user devices 102 include a desktop computer, a laptop computer, and a personal digital assistant, each of which communicates over a wireline or wireless connection. These user devices 102 and their associated connections are for illustration only. Any other or additional computing or communication devices may be used in the system 100. Each user device 102 includes any hardware, software, firmware, or combination thereof for accessing the task/process management server 106.

The network 104 is capable of communicating with the user devices 102 and the task/process management server 106. The network 104 facilitates communication between components of the system 100. For example, the network 104 may communicate Internet Protocol (IP) packets, frame relay frames, Asynchronous Transfer Mode (ATM) cells, or other suitable information. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

The task/process management server 106 is coupled to the network 104 and the database 108. The task/process management server 106 supports the creation and maintenance of various tasks or processes involving users of the user devices 102. For example, the task/process management server 106 may receive information defining a new task and assigning that task to one or more users. The task/process management server 106 may also track the status of the tasks and generate reminders that the tasks need to be completed. The task/process management server 106 may further generate reports or allow users to view all of the tasks assigned to or controlled by them.

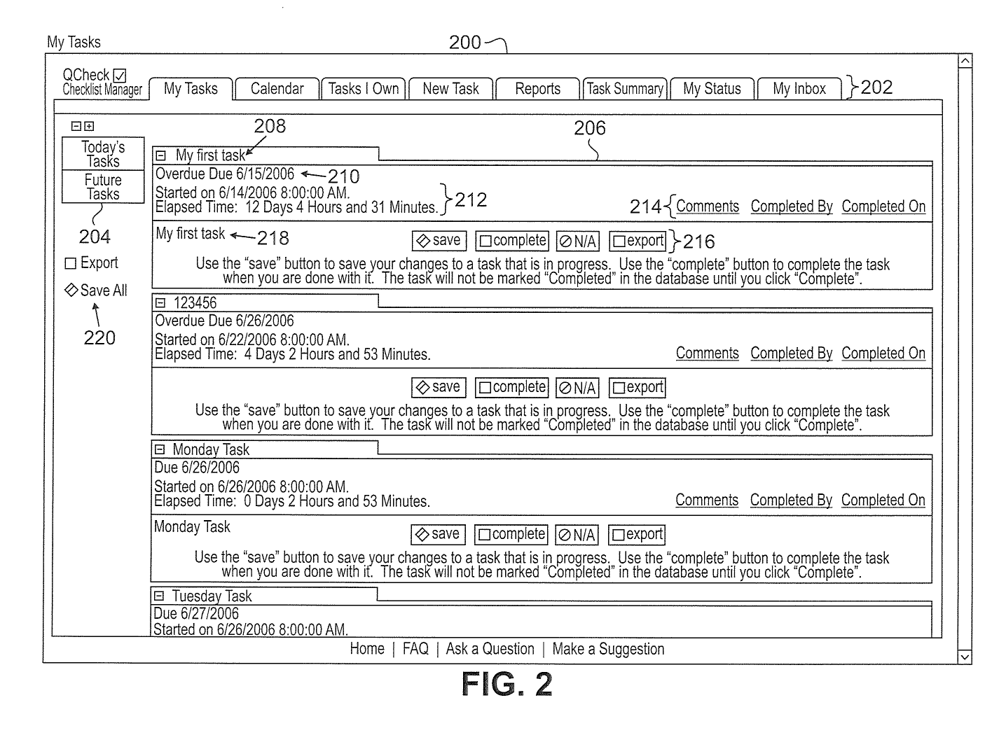

The task/process management server 106 includes any hardware, software, firmware, or combination thereof for process or task management. For example, the task/process management server 106 could include one or more processors 110 and one or more memories 112 containing data and instructions used by the one or more processors 110. The memories 112 could include, for example, one or more read-only memories (ROM), random access memories (RAM), magnetic storage media such as hard drives, and optical storage media such as CD or DVD drives. In this example, the task/process management functionality could represent one or more applications executed by the processor(s) 110. Also, the task/process management server 106 may receive input from users in any suitable manner. As a particular example, the task/process management server 106 may execute one or more applications that support a graphical user interface. One example of a graphical user interface is shown in FIGS. 2 through 58, which are described below.

The database 108 is coupled to the task/process management server 106. The database 108 stores various information used, generated, or collected by the task/process management server 106 to support task or process management. For example, the database 108 may include task information, which generally defines the tasks to be performed. The database 108 may also include task-related information, such as the status of the tasks, the identity of the users that are allowed to view or modify the tasks, and various other information. The database 108 could further include user comments or annotations about the tasks. The database 108 includes any hardware, software, firmware, or combination thereof for storing and facilitating retrieval of information. The database 108 may use any of a variety of data structures, arrangements, and compilations to store and facilitate retrieval of information.

Although FIG. 1 illustrates one example of a system 100 for task and process management, various changes may be made to FIG. 1. For example, the system 100 may include any number of user devices, networks, servers, and databases. Also, while FIG. 1 illustrates that one database 108 is coupled directly to the task/process management server 106, any number of databases 108 may reside at any location or locations accessible by the server 106. In addition, while FIG. 1 illustrates the use of a server 106 in the system 100, the functionality of the server 106 could be implemented on other device(s). As particular examples, the task and process management functionality could be implemented as a stand-alone application executed by a desktop or laptop computer, or the functionality could be distributed across multiple computing devices.

FIGS. 2 through 58 illustrate an example graphical user interface 200 for task and process management in accordance with this disclosure. The graphical user interface 200 could, for example, be provided by one or more applications executed by the task/process management server 106. This embodiment of the graphical user interface 200 is for illustration only. Other embodiments of the graphical user interface 200 may be used without departing from the scope of this disclosure. Also, for ease of explanation, the graphical user interface 200 is described with respect to the task/process management server 106 in the system 100 of FIG. 1. The graphical user interface 200 could be used by any other suitable device and in any other suitable system.

The graphical user interface 200 is generally used to view, create, and manage tasks and processes formed from multiple tasks. The tasks and processes can involve any number of users. As shown in FIG. 2, the graphical user interface 200 includes a set of tabs 202. The tabs 202 control which task-related information is displayed in the remaining portion of the graphical user interface 200.

Selection of the “My Tasks” tab 202 displays the information in the graphical user interface 200 that is shown in FIG. 2. In FIG. 2, a user is able to view the tasks that are currently due to be completed by the user and/or tasks that are due to be completed by the user in the future. Two selection buttons 204 allow the user to view either the tasks currently due or the future tasks.

In either case, the current or future tasks are identified using task entries 206. Each task entry 206 identifies a different task assigned to the user for completion. A task entry 206 includes a header 208 identifying the name of the task to be completed, a due date/time 210 (possibly with an “Overdue” indication if the task is currently overdue), and time information 212 identifying the start time and elapsed time for the task's performance. If a task associated with a task entry 206 has been completed, this can be identified in any suitable manner, such as when the header 208 of the task entry 206 is altered (like making the text in the header 208 grey instead of black).

Each task entry 206 also includes various links 214, which can be selected by the user to retrieve, view, or provide different task-related information. This information includes comments about a task, an indication of who completed a task, and an indication of when the task was completed. Each task entry 206 further includes various buttons 216, which allow the user to save changes to a task, mark that the task has been completed, mark that the task is no longer applicable, and export the task (such as to a MICROSOFT EXCEL or other spreadsheet). In addition, each task entry 206 could include an optional text section 218 identifying any comments, notes, or other text associated with the task.

The graphical user interface 200 in FIG. 2 also includes two function buttons 220, which allow the user to export all listed tasks (such as to a spreadsheet) and to save any changes to all listed tasks. This allows the user to make changes to multiple task entries 206 or to export multiple task entries 206 without having to use the buttons 216 in each individual entry 206.

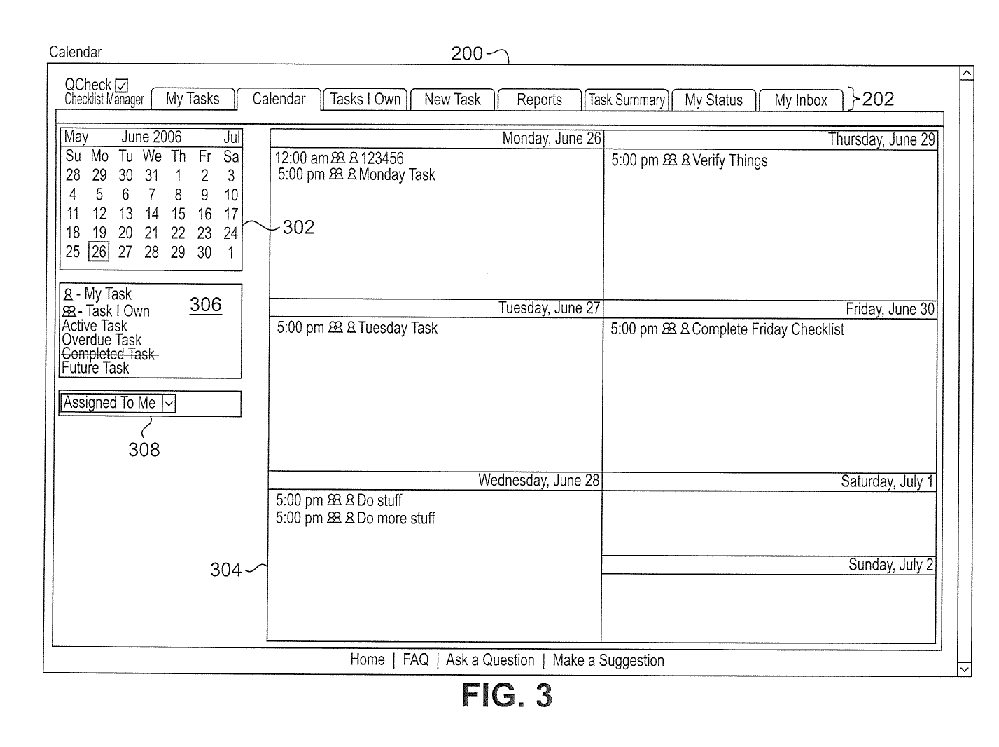

Selection of the “Calendar” tab 202 displays the information in the graphical user interface 200 that is shown in FIG. 3. In FIG. 3, the graphical user interface 200 includes a month calendar 302, which displays a calendar for a specified month and year. The user can select a particular day during the displayed month, and the user can move to the previous or subsequent month at the top of the displayed calendar 302.

When the user selects a day in the displayed month, the graphical user interface 200 presents the user with a weekly task summary 304. The weekly task summary 304 identifies the tasks associated with the user during a specified week, which includes the day selected by the user in the month calendar 302. The selected day could, for example, represent the starting day in the weekly task summary 304. In some embodiments, the month calendar 302 by default is set to the current month and year and the current day is selected, causing the weekly task summary 304 by default to display the user's tasks for the upcoming week.

A legend 306 identifies the different types of tasks listed in the weekly task summary 304. In this example, the legend 306 indicates that both tasks assigned to the user and tasks “owned” (controlled) by the user are displayed in the weekly task summary 304. The legend 306 also identifies different text colors or fonts that are used to identify active, overdue, completed, and future tasks.

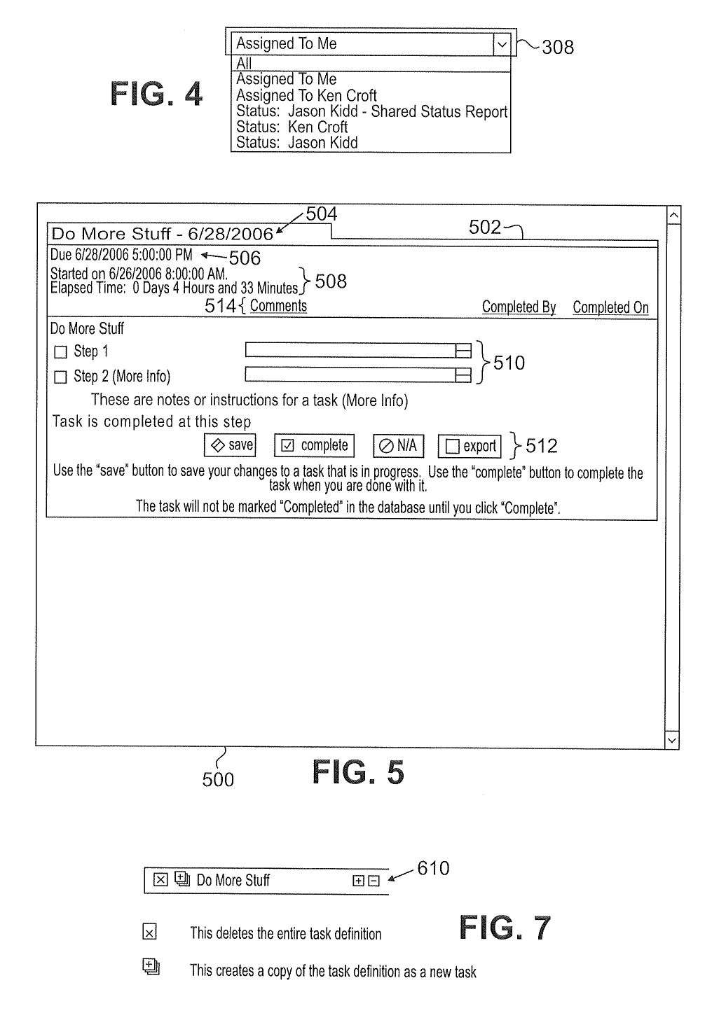

A drop-down menu 308 in FIG. 3 controls which tasks are identified in the weekly task summary 304. As shown in FIG. 4, the drop-down menu 308 could be used to select only tasks assigned to the user or only tasks assigned by the user to another user. The drop-down menu 308 could also be used to select only tasks that appear on a specific status report. In addition, the drop-down menu 308 could be used to select all tasks associated with the user.

If a task entry 206 is selected in FIG. 2 or a task in the weekly task summary 304 is selected in FIG. 3, a display 500 as shown in FIG. 5 may be presented to the user. The display 500 allows the user to view additional information about the selected task. Here, the display 500 includes a task entry 502, which could represent an expanded version of a task entry 206 in FIG. 2. The task entry 502 includes a header 504, a due date/time 506, and start and elapsed times 508 for the task's performance. The task entry 502 also includes a step description area 510, which defines one or more steps to be performed during performance of the task. The step description area 510 includes, for each step, a text box describing the step and a completion checkbox, which can be selected by the user to indicate that the step has been completed. The task entry 502 further includes buttons 512 and links 514, which may function in the same or similar manner as the buttons 216 and links 214 in FIG. 2.

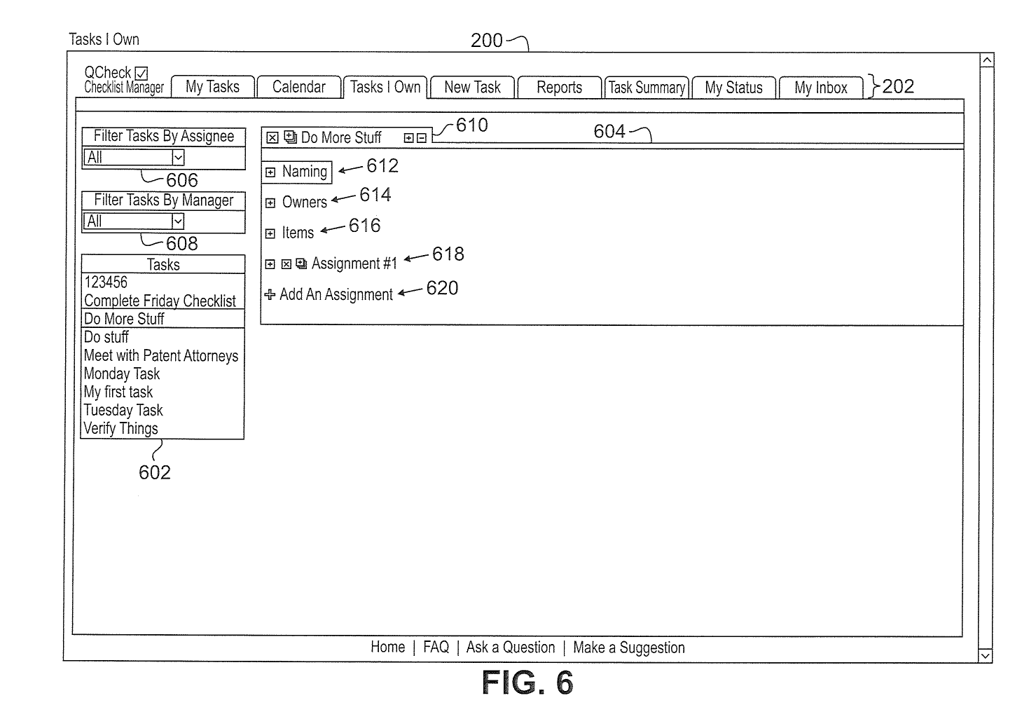

Selection of the “Tasks I Own” tab 202 displays the information in the graphical user interface 200 that is shown in FIG. 6. In FIG. 6, the user is able to view tasks that are currently owned by the user, meaning the user has the authority to modify the owned tasks. The tasks that the user owns are displayed in a task list 602. If the user selects one or more tasks in the task list 602, a task entry 604 for each selected task is displayed to the user. Each task entry 604 allows the user to define various aspects of a selected task, such as by allowing the user to rename the task or assign the task to different users. The task list 602 can be filtered using an assignee search 606, which uses a drop-down menu identifying different assignees. Selection of a particular assignee limits the task list 602 to any tasks associated with that assignee. Similarly, the task list 602 can be filtered using a manager search 608, which uses a drop-down menu to identify different owners. Selection of a particular owner limits the task list 602 to any tasks associated with that owner.

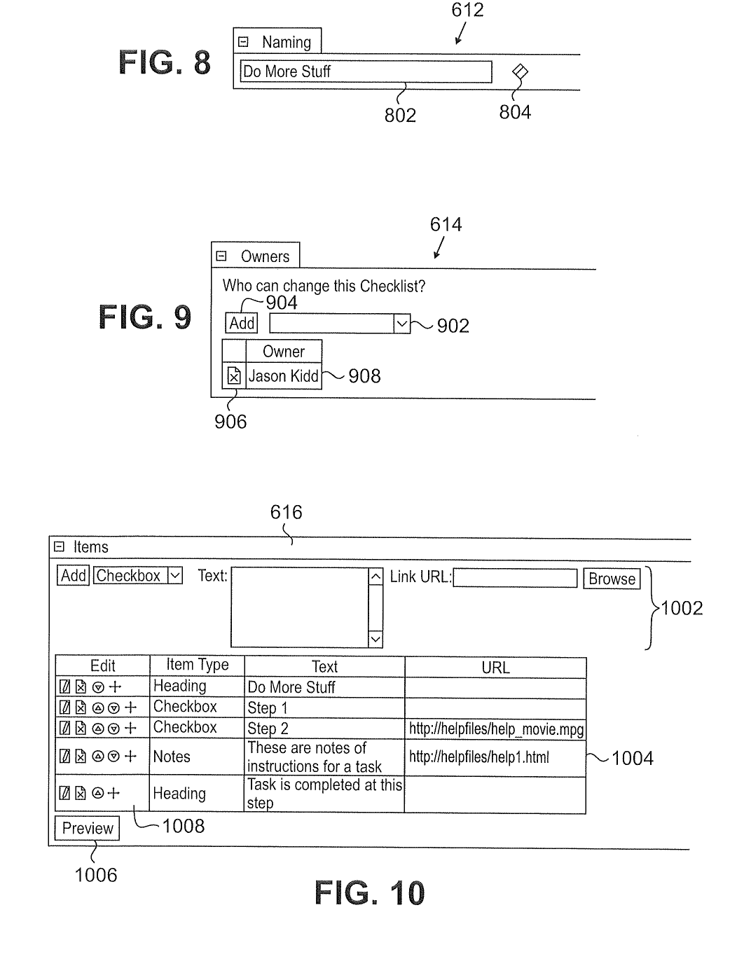

In this example, the task entry 604 supports various operations that can be invoked by the user. For example, a heading 610 (shown in more detail in FIG. 7) can be used to delete the task entry 604 or to copy the task entry 604 into a new task entry. A naming box 612 (shown in more detail in FIG. 8) can be expanded to reveal a text entry box 802 and a save button 804, which allow the user to rename the task. An owners box 614 (shown in more detail in FIG. 9) can be expanded and used to specify which users can modify the task. For example, a drop-down menu 902 can be used to select another user, and the selected user is added as an owner using an add button 904. Also, an existing owner can be deleted using a delete button 906 for that owner, which removes the owner from a table 908 of current owners.

An items box 616 (shown in more detail in FIG. 10) can be expanded and used to define the task entry 502 for the selected task. The items box 616 includes an items definition area 1002, which allows the user to define how items associated with the task are displayed in the task entry 502. For example, the definition area 1002 may allow the user to define the header 504, step description area 510, and other elements in the task entry 502. Any defined headings and subheadings could use a different font in the task entry 502, such as larger and bolded or italicized text. Any checkbox items represent the steps that need to be completed before the task can be marked as complete. Text associated with checkbox items can be displayed in the step description area 510. Content identified by a Uniform Resource Locator (URL) or other link can be accessed by selecting a “More Info” link in the task entry 502.

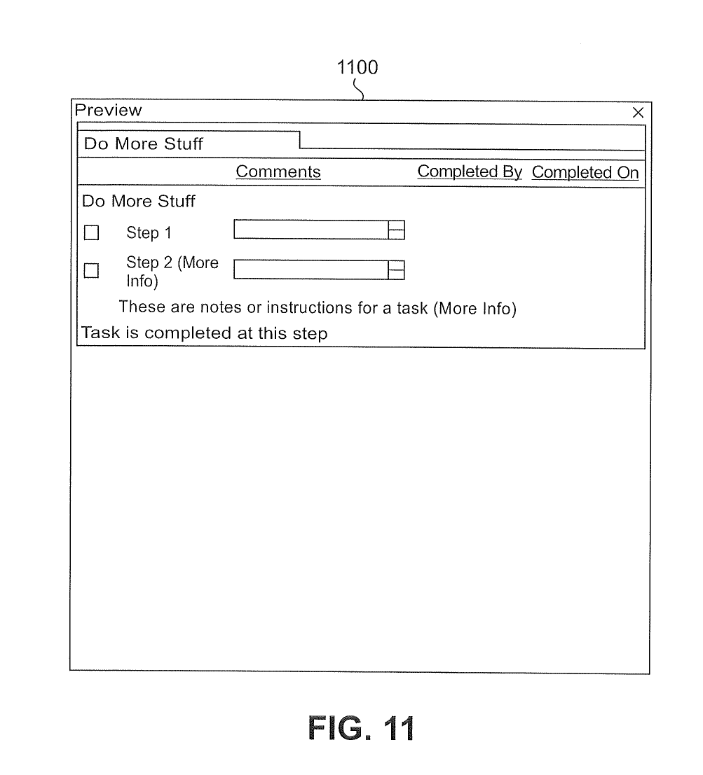

All defined items for the task are identified in a table 1004, and the defined items for the task can be previewed using a preview button 1006. Various buttons 1008 in the table 1004 can be selected to edit or delete an item, move an item up or down one space in the table 1004, or move an item anywhere within the table 1004. The preview button 1006 allows the user to preview how the task entry 502 for the current task would appear using the definition provided in the items box 616. For example, selection of the preview button 1006 could present the user with a display 1100 shown in FIG. 11, which shows the user how the task entry 502 would appear once the task is completely defined.

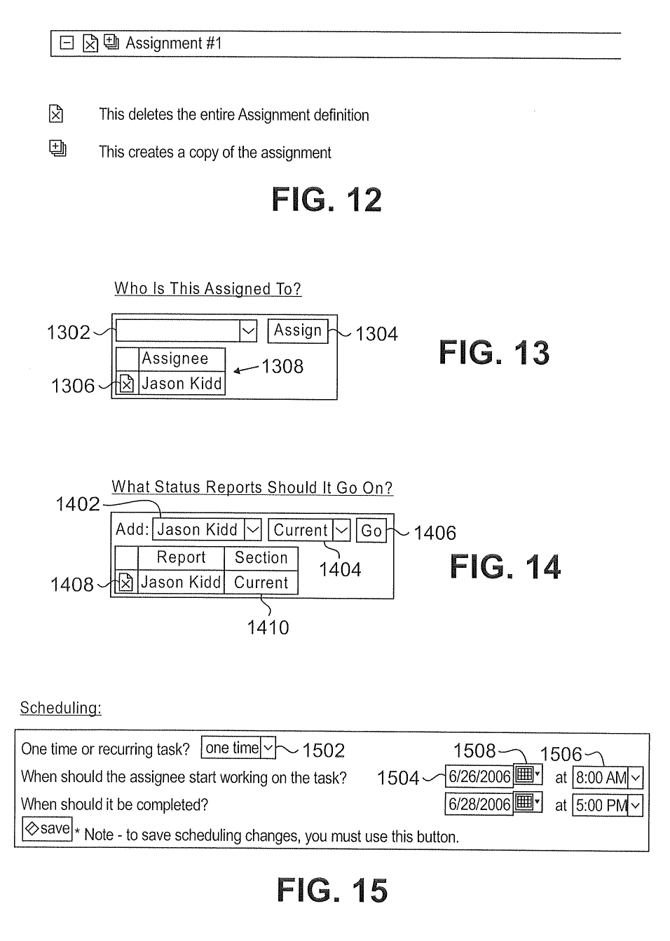

Returning to FIG. 6, one or more assignment boxes 618 can be used to assign the task selected in the task list 602 to other users. For example, a manager could use the assignment boxes 618 to assign multiple tasks of a process to different employees reporting to the manager. In this example, each assignment box 618 includes a header, which is shown in more detail in FIG. 12. The header allows the user to delete a particular assignment box 618 or to create a copy of the assignment box 618.

If the user selects an “Add an Assignment” button 620 in an assignment box 618, the user may receive various displays shown in FIGS. 13 through 24. These displays are used to guide the user in assigning the task to himself or herself or to another user.

In FIG. 13, the user uses a drop-down menu 1302 and an assign button 1304 to assign the task to another user, and a delete button 1306 can be used to delete an assignee from a table 1308 of existing assignments. In FIG. 14, the user can choose to have the task appear on a status report controlled by that user. A drop-down menu 1402 allows the user to select the status report, and a drop-down menu 1404 allows the user to select the section of the selected status report in which the task appears. A go button 1406 adds the task to the identified report and section, and a delete button 1408 removes the task from a previously specified report and section identified in a table 1410.

In FIGS. 15 through 20, the user specifies the scheduling of the task, such as when the task should be started and completed by the assignee of the task. As shown here, the scheduling varies depending on whether the task being assigned is a one-time task (to be completed once) or a recurring task (to be completed multiple times). A drop-down menu 1502 allows the user to specify if the task is a one-time task or a recurring task.

If the user specifies a one-time task, the user can configure the scheduling of the assigned task as shown in FIG. 15. The user can specify the date(s) 1504 and time(s) 1506 when performance of the task should begin and be completed. In this example, text boxes can be used to enter the dates 1504, and drop-down menus can be used to select the times 1506. Also, calendar buttons 1508 can be selected and used to view a calendar, where a date selected in a calendar is used as one of the dates 1504.

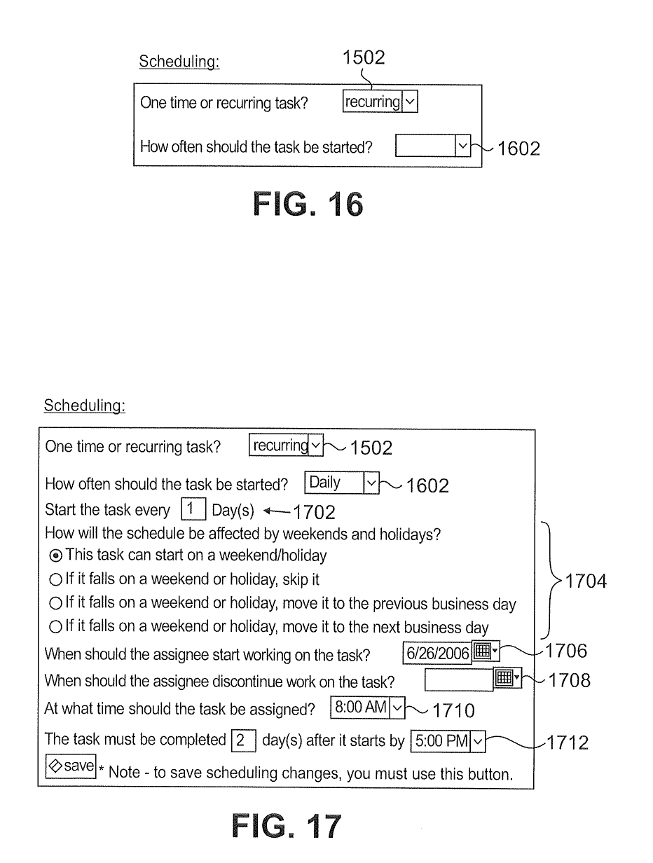

As shown in FIG. 16, if the user specifies a recurring task using the drop-down menu 1502, the user then uses a second drop-down menu 1602 to define the interval between occurrences. If the user indicates that the task will occur daily (including every few days), the user can schedule the assigned task as shown in FIG. 17. Here, the user can specify the interval 1702 (in days) between occurrences of the assigned task. The user can also use a selection menu 1704 to indicate how the scheduling is affected by weekends and holidays. For example, the user can indicate that the assigned task can start on a weekend or holiday or that the assigned task should be skipped if it falls on a weekend or holiday. The user can also indicate that the assigned task should be moved to a previous or next business day if it falls on a weekend or holiday. The user can further define a start date 1706 and an end date 1708 for the assigned task, which identify when the recurring task should begin and end. In addition, the user can define a time 1710 when the task should be assigned (when the task appears as a “current” task to the assignee) and a deadline 1712 for completing the task.

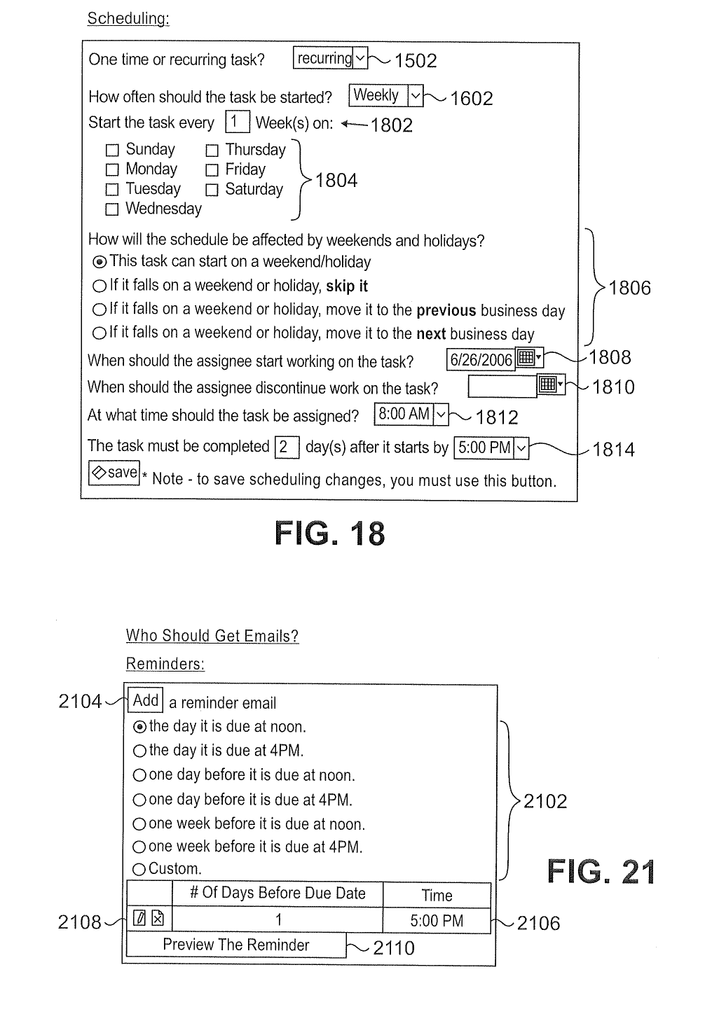

If the user indicates that a recurring task will occur weekly (including every few weeks), the user can schedule the assigned task as shown in FIG. 18. In FIG. 18, the user can specify the interval 1802 (in weeks) between occurrences of the task and the day of the week 1804 that the task should begin. The user can also use a selection menu 1806 to indicate how the scheduling is affected by weekends and holidays. In addition, the user can define a start date 1808 and an end date 1810 for the recurring task, a time 1812 when the task should be assigned, and a deadline 1814 for completing the task.

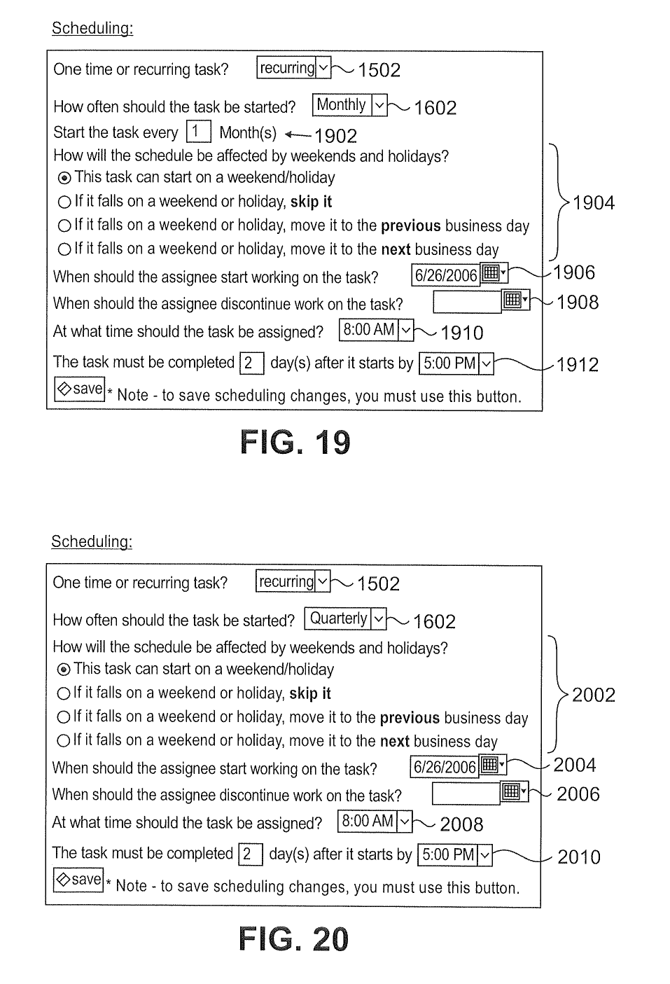

If the user indicates that a recurring task will occur monthly (including every few months), the user can schedule the assigned task as shown in FIG. 19. As shown here, the user can specify the interval 1902 (in months) between occurrences of the assigned task. The user can also use a selection menu 1904 to indicate how the scheduling is affected by weekends and holidays. In addition, the user can define a start date 1906 and an end date 1908 for the task, a time 1910 when the task should be assigned, and a deadline 1912 for completing the task.

If the user indicates that a recurring task will occur quarterly, the user can schedule the assigned task as shown in FIG. 20. Here, the user can use a selection menu 2002 to indicate how the scheduling is affected by weekends and holidays. The user can also define a start date 2004 and an end date 2006 for the task, a time 2008 when the task should be assigned, and a deadline 2010 for completing the task. Other or additional periods could also be defined for recurring tasks, such as yearly tasks.

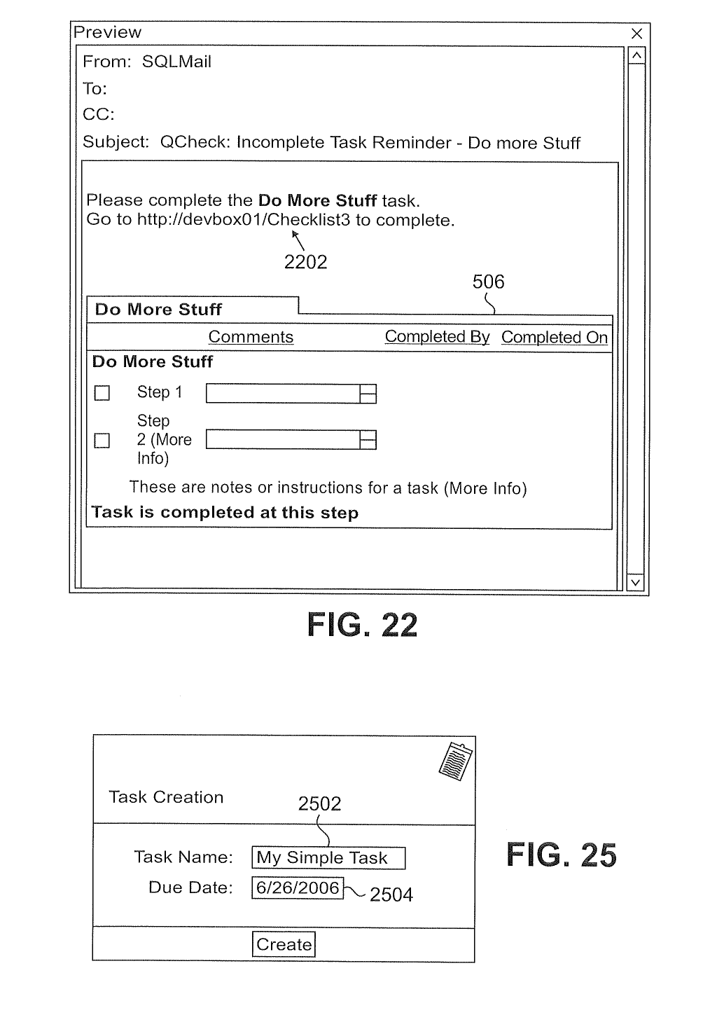

In FIGS. 21 through 23, an owner of a task (when assigning the task to other users) can control how reminders and alerts associated with the task are sent. In FIG. 21, the user can use a menu 2102 to select when an email reminder should be sent to any users assigned to perform the task. Multiple email reminders could be used for a single task. An add button 2104 adds the selected email reminder to a table 2106, which identifies all email reminders currently defined for the task. Buttons 2108 allow the user to modify an email reminder (such as by changing the time or number of days shown in the table 2106) or to delete an email reminder. A preview button 2110 allows the user to preview a selected email reminder, such as an email reminder currently being defined. An example display presented to the user upon selection of the preview button 2110 is shown in FIG. 22. As shown here, the reminder could include a link 2202 to the task entry 506 and a copy of the task entry 506.

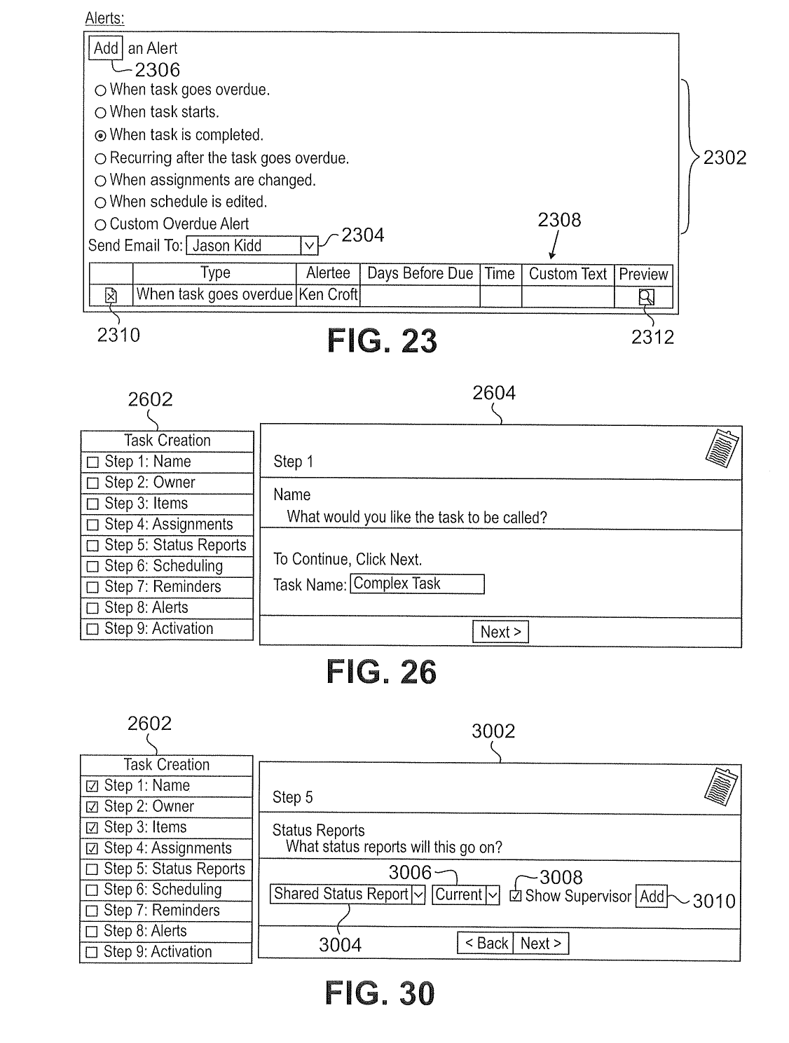

Alerts, which can be similar to email reminders, can be used to notify users of various task-related events (even if those users have not been assigned the task). This could be useful, for example, in notifying an employee's supervisor that the employee has failed to complete a specified task or task step. As shown in FIG. 23, the user can use a menu 2302 to select the event associated with an alert. The user can also use a drop-down menu 2304 to select who will receive the alert. An add button 2306 is used to create the alert being defined, which adds the alert to a table 2308. A delete button 2310 allows a created alert to be deleted from the table 2308, and a preview button 2312 allows the user to preview the alert.

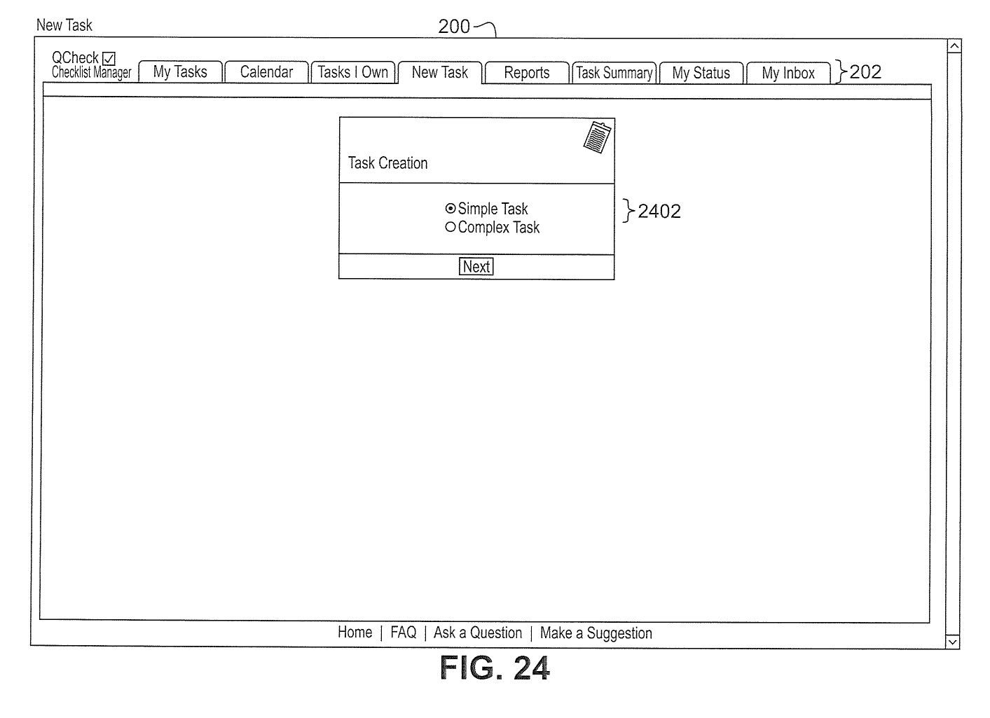

Selection of the “New Task” tab 202 displays the information in the graphical user interface 200 that is shown in FIG. 24. In FIG. 24, the user initiates creation of a new task. More specifically, the user can use a menu 2402 to initiate the creation of either a simple task or a complex task. In general, a simple task may require very little input from the user (with default values used for many task characteristics), while a complex task allows the user to customize all aspects of the task being defined. Once defined, tasks added using the “New Task” tab 202 appear under the “Tasks I Own” tab 202.

If the user chooses to create a simple task, the user may define the simple task as shown in FIG. 25. Here, the user is allowed to enter a task name 2502 and a due date 2504 for the task. In this example, the remaining characteristics of the task are assigned default values. For example, the default owner and the default assignee of the task could be the user creating the task. The default items in the task entry 502 for the new task could include a single header or checkbox, which is the same as the task name 2502. The default scheduling could be as a one-time task, starting at 8:00 AM on the date the task is created and ending at 5:00 PM on the specified due date 2504. The default reminder could be a single reminder sent to the user prior to the due date 2504. The default alert could be a single alert sent to the user's supervisor when the task goes overdue, or no default alert could be defined.

If the user chooses to create a complex task, the user may define the complex task as shown in FIGS. 26 through 34. In FIG. 26, the user is provided with a task creation list 2602, which identifies the steps to be completed in order to create the new complex task. The user is also presented with a task naming box 2604, which allows the user to specify the name of the new complex task.

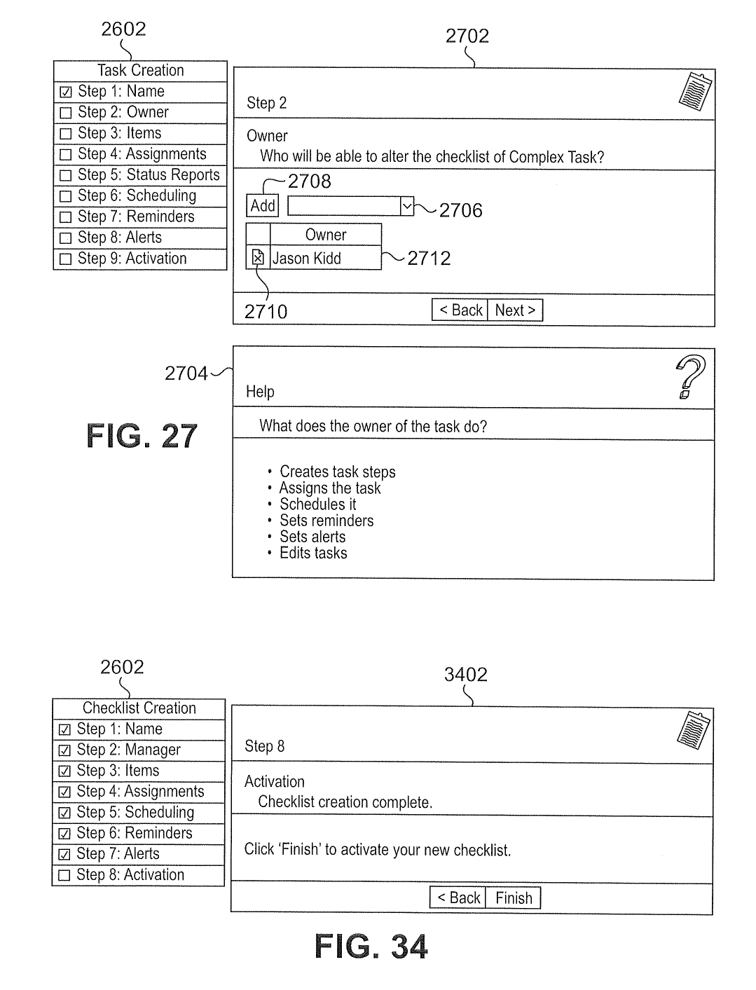

As shown in FIG. 27, the user is provided with an owners box 2702 and a help box 2704. The owners box 2702 allows the user to identify other users who have the authority to modify the new complex task. A drop-down menu 2706 allows the user to select possible owners, and an add button 2708 adds the selected user in the menu 2706 as an owner. A delete button 2710 deletes an existing owner from a table 2712 of owners.

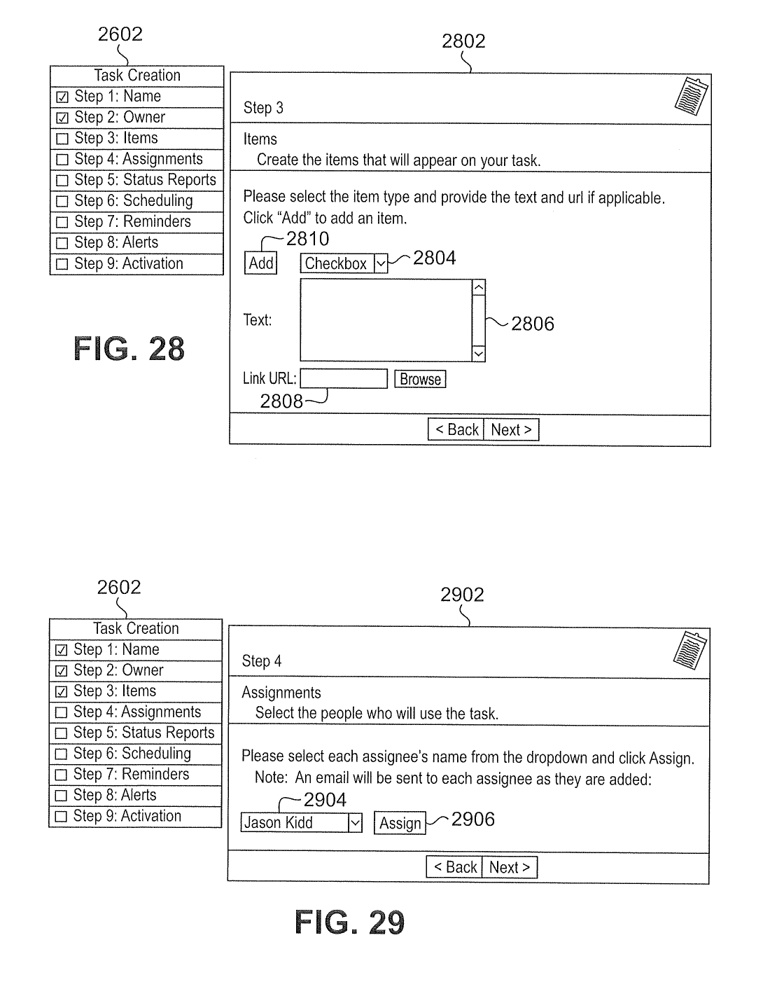

In FIG. 28, the user is allowed to create the items for the new complex task with an items box 2802. The items box 2802 may operate in a similar manner as the items box 616 shown in FIG. 10. Here, the user is allowed to add headings, subheadings, checkboxes, notes, or other contents for the task entry 502 of the new complex task. For example, the user can use a drop-down menu 2804 to select the item to be added, provide text 2806 or a link 2808, and select an add button 2810 to add the item.

In FIG. 29, the user is allowed to assign the new complex task to one or more other users with an assignment box 2902. For example, the user can select another user from a drop-down menu 2904 and use an assign button 2906 to assign the complex task to the selected user.

As shown in FIG. 30, the user can associate the new complex task with one or more of the user's status reports using a status report box 3002. For example, the user can select a status report using a drop-down menu 3004 and a section of that status report using a drop-down menu 3006. The user can also indicate whether the supervisor of a task assignee is listed in the status report using a checkbox 3008. In addition, the user can select an add button 3010 to associate the identified status report with the new complex task.

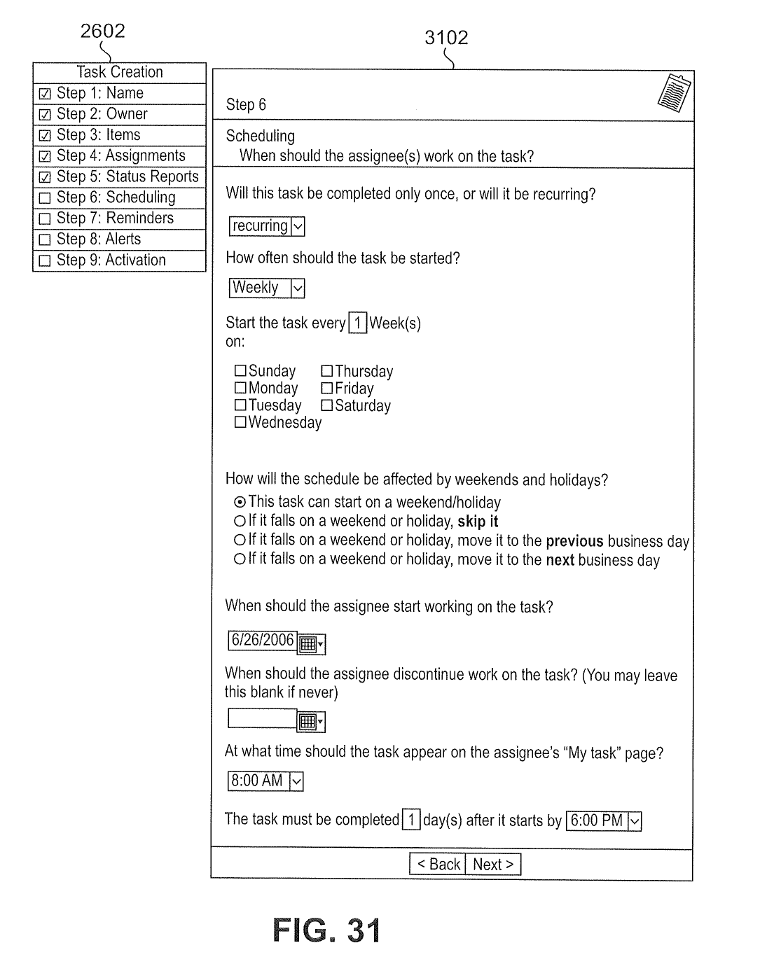

In FIG. 31, the user is allowed to specify the scheduling of the new complex task using a scheduling box 3102. The contents of the scheduling box 3102 may vary in a manner similar to that shown in FIGS. 15 through 20. For example, the contents of the scheduling box 3102 may vary depending on whether the new complex task is a one-time or recurring task and the period between occurrences (if any).

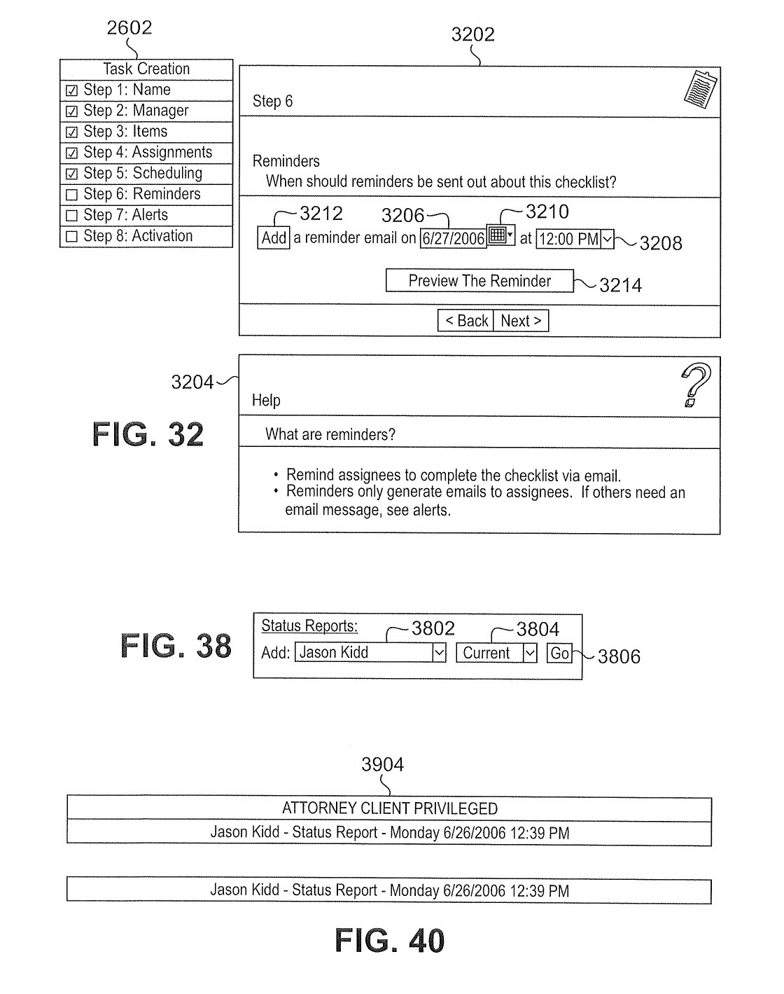

As shown in FIG. 32, the user can define reminders for the new complex task. Here, the user is presented with a reminders box 3202 and a help box 3204. The user can use the reminders box 3202 to specify when email reminders associated with the new complex task are sent. For example, the user can specify the date 3206 and time 3208 of a reminder. The date 3206 could be entered manually or selected using a calendar, which is displayed in response to the selection of a calendar button 3210. The time 3208 can be selected from a drop-down menu. An add button 3212 can be used to create a new reminder. The user can also preview the reminder using a preview button 3214. The use of reminders could be limited to those users who have been assigned the complex task.

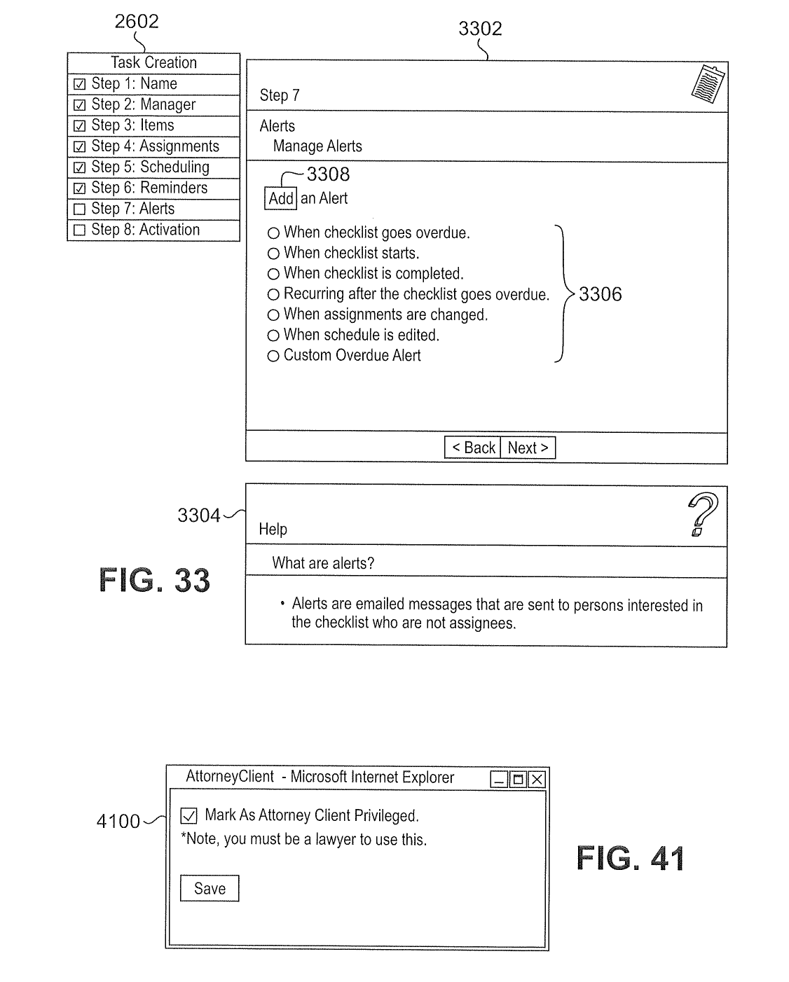

In FIG. 33, the user can define alerts for the new complex task. The user is presented with an alerts box 3302 and a help box 3304. The user can use the alerts box 3302 to specify when alerts associated with the complex task are sent. For example, the user can select a type of alert from a menu 3306 and select an add button 3308 to create the new alert. The use of alerts could be limited to those users who have not been assigned the complex task. Finally, in FIG. 34, the user is given the option of completing the creation of the new complex task and activating the task.

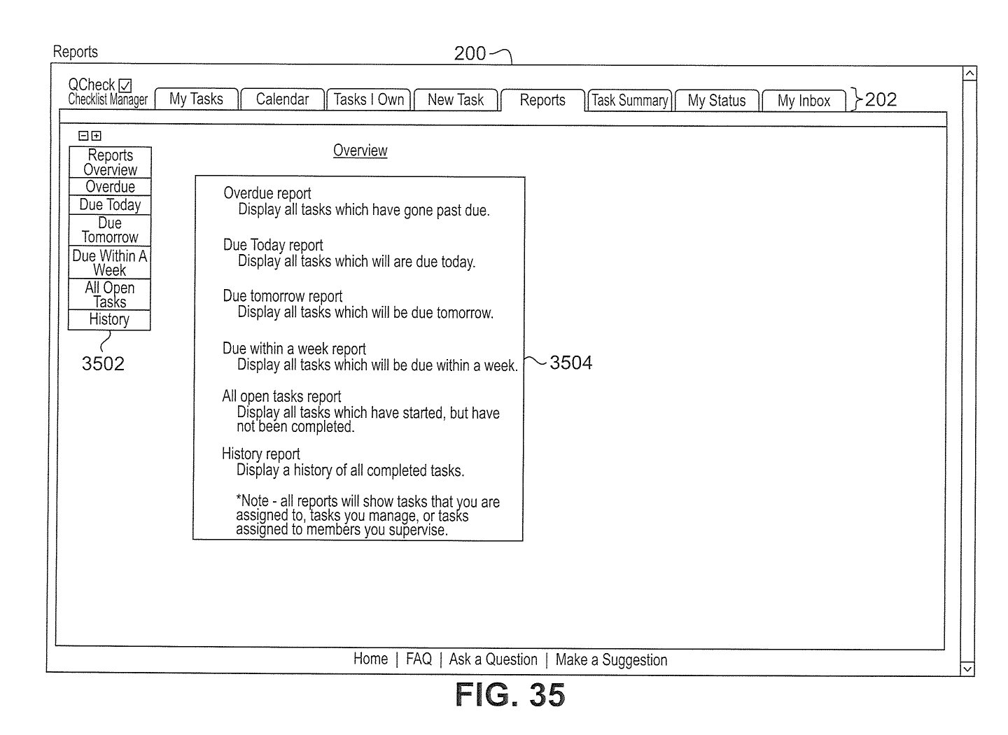

Selection of the “Reports” tab 202 displays the information in the graphical user interface 200 that is shown in FIG. 35. In FIG. 35, the user is able to select and view different reports dealing with the tasks associated with the user. For example, the user can be provided with a list 3502 of different reports that can be generated. The list 3502 could include standard reports or one or more custom reports. In this example, a reports overview 3504 has been selected and presented to the user. The user may use the overview 3504 to select specific reports, each of which may be associated with different filtering criteria for selecting the tasks displayed for that report.

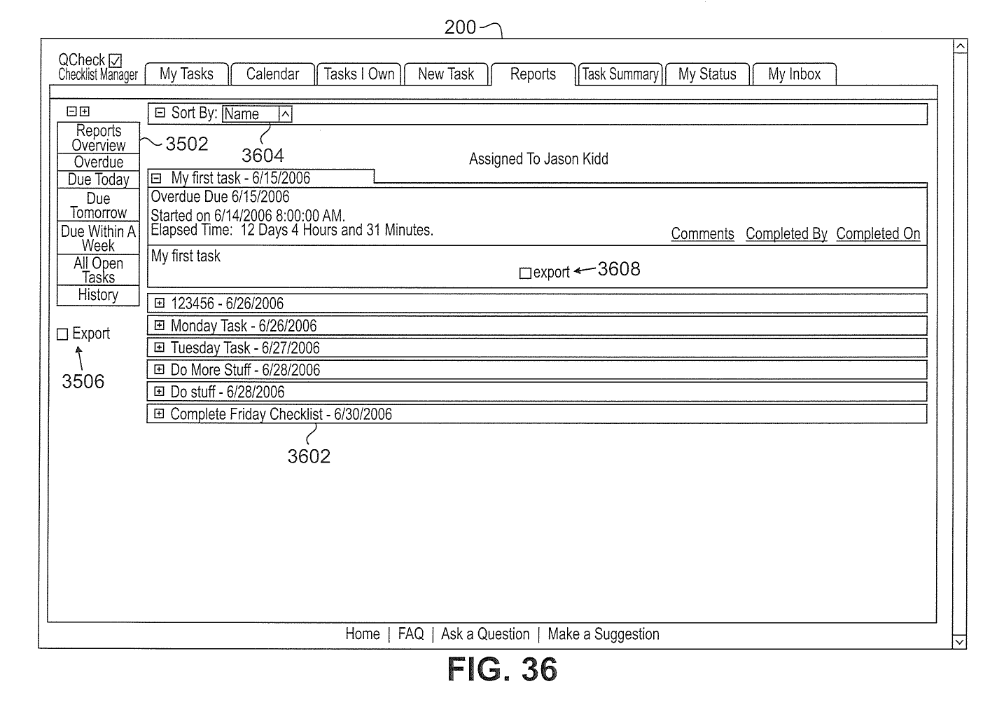

As shown in FIG. 36, the user can choose to view an “All Open Tasks” report 3602. This report 3602 identifies all tasks associated with the user that have not been completed. A drop-down menu 3604 is provided for selecting different ways to sort the identified tasks. Also, the tasks can be collectively exported using an export button 3606, or each task can be exported individually using an export button 3608.

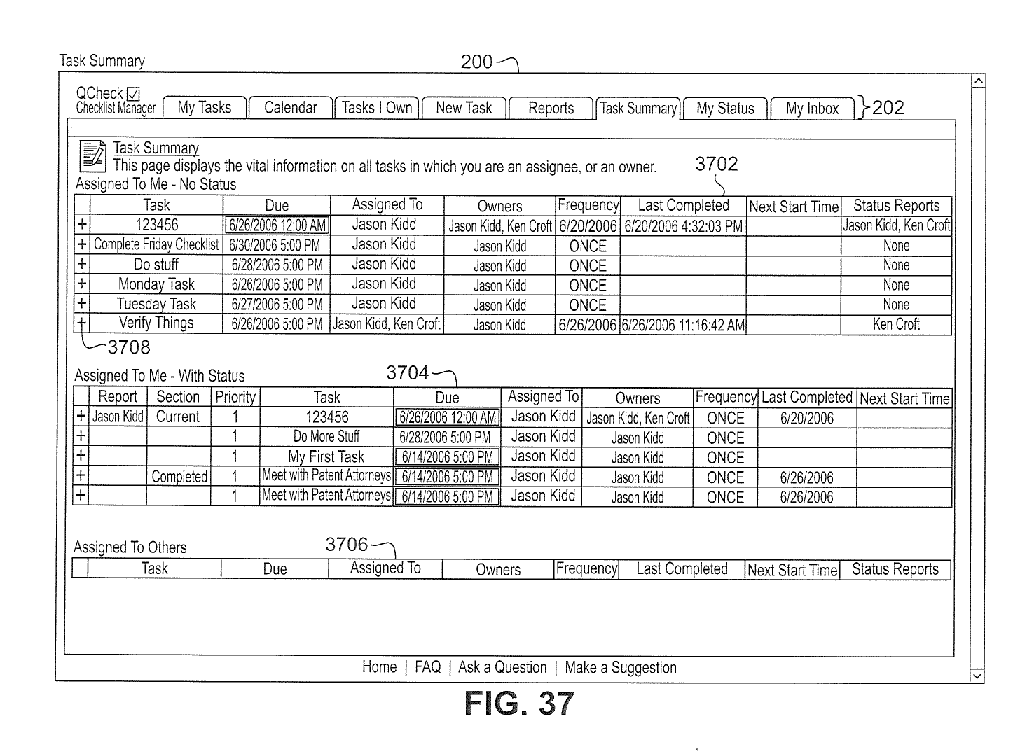

Selection of the “Task Summary” tab 202 displays the information in the graphical user interface 200 that is shown in FIG. 37. In FIG. 37, the user is able to view a summary of the various tasks associated with the user. For example, as shown in FIG. 37, the tasks could be divided into three sections 3702-3706. Section 3702 lists the tasks that have been assigned to the current user (either by himself or herself or by another user), where the tasks have not been assigned to any of the current user's status reports. Section 3704 identifies the tasks that have been assigned to the current user, where the tasks have also been assigned to at least one of the current user's status reports. Section 3706 identifies the tasks that the current user owns and has assigned to other users. Here, the tasks listed in the sections 3702-3706 that are overdue can be distinguished from other tasks, such as by having their due dates shaded in a different color (like red).

Among other things, the user is allowed to move tasks between sections in FIG. 37. For example, the user could select a move button 3708 associated with a task to move the task from section 3702 to section 3704. This may require the user to assign the task to a status report, such as by using the assignment box shown in FIG. 38. Here, the user can use drop-down menus 3802-3804 to select a status report and report section for the task, and a go button 3806 initiates the assignment of the task to the identified status report and section. Also, by selecting a displayed task in FIG. 37 (such as by selecting a hyperlink represented by the task's due date), the user could view additional details of the selected task. The details could, for example, be presented to the user using the display 500 of FIG. 5.

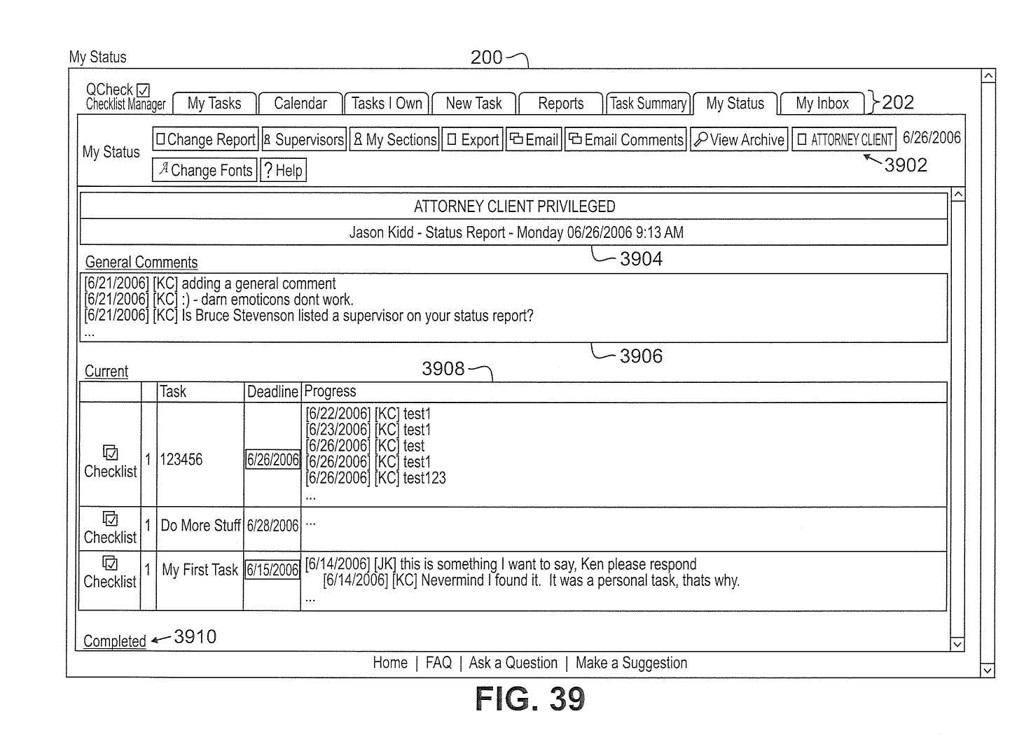

Selection of the “My Status” tab 202 displays the information in the graphical user interface 200 that is shown in FIG. 39. In FIG. 39, the user is given a wide range of options for logically grouping related tasks for review by interested parties in the form of one or more status reports. Among other things, users assigned to tasks and any interested parties can have a running dialog that is recorded in a status report. As a particular example, this tab 202 may be useful for grouping tasks by individual users or for grouping tasks by project.

As shown in FIG. 39, a toolbar includes a number of buttons 3902, which can be selected as described below to invoke various features. A status report displayed in FIG. 39 includes a header 3904, general comments 3906, a list 3908 of current uncompleted tasks, and a list 3910 of completed tasks. The header 3904 (two examples of which are shown in more detail in FIG. 40) identifies the user associated with the status report and the time/date of the status report. Optionally, the header 3904 can indicate that the contents of the status report are protected by attorney-client privilege or some other confidentiality obligation. The confidentiality portion of the header 3904 can be controlled using the “Attorney Client” button 3902, which when selected presents the user with the warning display 4100 in FIG. 41.

The general comments section 3906 in FIG. 39 may contain comments or other communications that are not related to a specific or individual task. Comments can be added to the general comments section 3906 by selecting an add comment link “ . . . ”. Also, a response to a comment can be entered by selecting the comment and providing the response. Original comments could be left justified, and responses could be indented or otherwise marked to distinguish them from original comments.

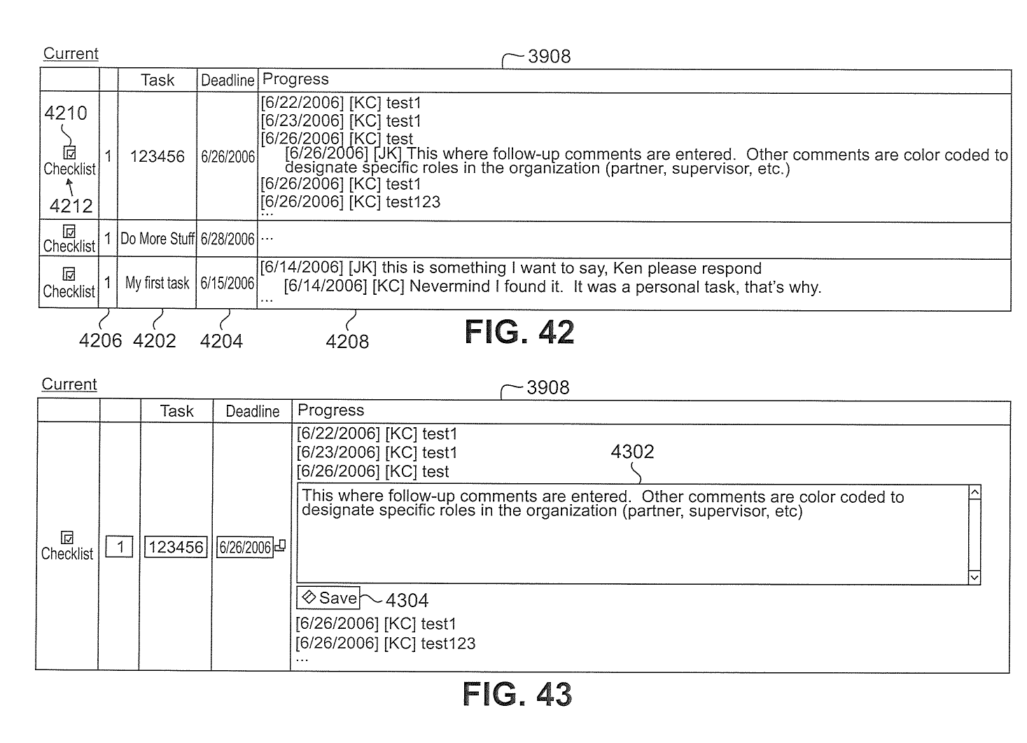

The list 3908 of current uncompleted tasks (shown in more detail in FIG. 42) identifies all of the tasks associated with the user that have been assigned and not completed. In this example, the list 3908 includes a name 4202, deadline 4204, and priority level 4206 for each current uncompleted task. Overdue tasks could be identified using a different background color for their deadlines 4204. The list 3908 also includes comments 4208. As with the general comments section 3906, new comments for each task can be added using the “ . . . ” link, and responses can be added by clicking on an existing comment. As shown in FIG. 43, clicking on an existing comment provides a text box 4302 for entering a response and a save button 4304 for saving the response. Returning to FIG. 42, each task in the list 3908 also includes a checklist link 4210, which can be selected to view the list of steps associated with that task. Each task also includes a completed checkbox 4212, which can be selected to move the associated task from the uncompleted list 3908 to the completed list 3910. The completed checkbox 4212 could be selected only if all steps in the task's checklist have been marked as complete.

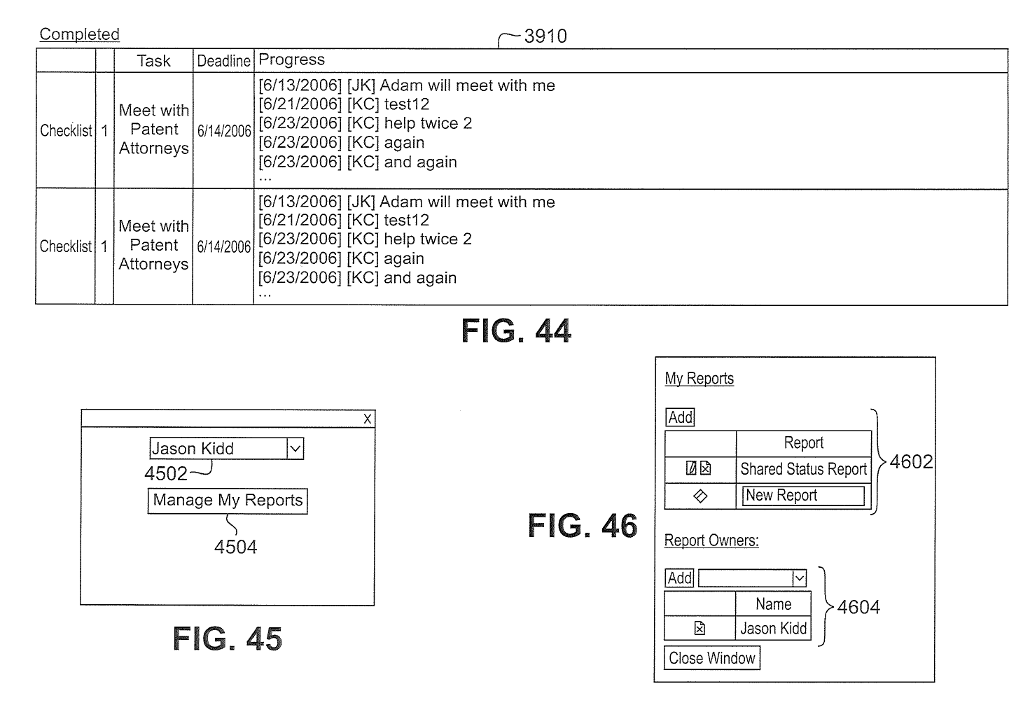

The list 3910 of completed tasks is shown in more detail in FIG. 44. In this example, the list 3910 is similar to the list 3908 shown in FIG. 42, except the tasks in the list 3910 do not include completed checkbox 4212 (since they are already complete). Completed tasks could be identified in the list 3910 for a specified period of time and then removed and archived in the database 108.

FIGS. 45 through 54 illustrate displays presented to the user upon selection of the various buttons 3902 shown in FIG. 39. In FIG. 45, the user may change the status report viewed under the “My Status” tab 202 by selecting the “Change Report” button 3902. This presents the user with a drop-down menu 4502, which allows the user to select and view any report managed by the user. The user can also select a manage button 4504, which presents the user with the display shown in FIG. 46. In FIG. 46, the user can use section 4602 to modify or delete existing reports or to define new reports. The user can also use section 4604 to add and delete other users as “owners” of a report, where owners of a report can view and modify that report.

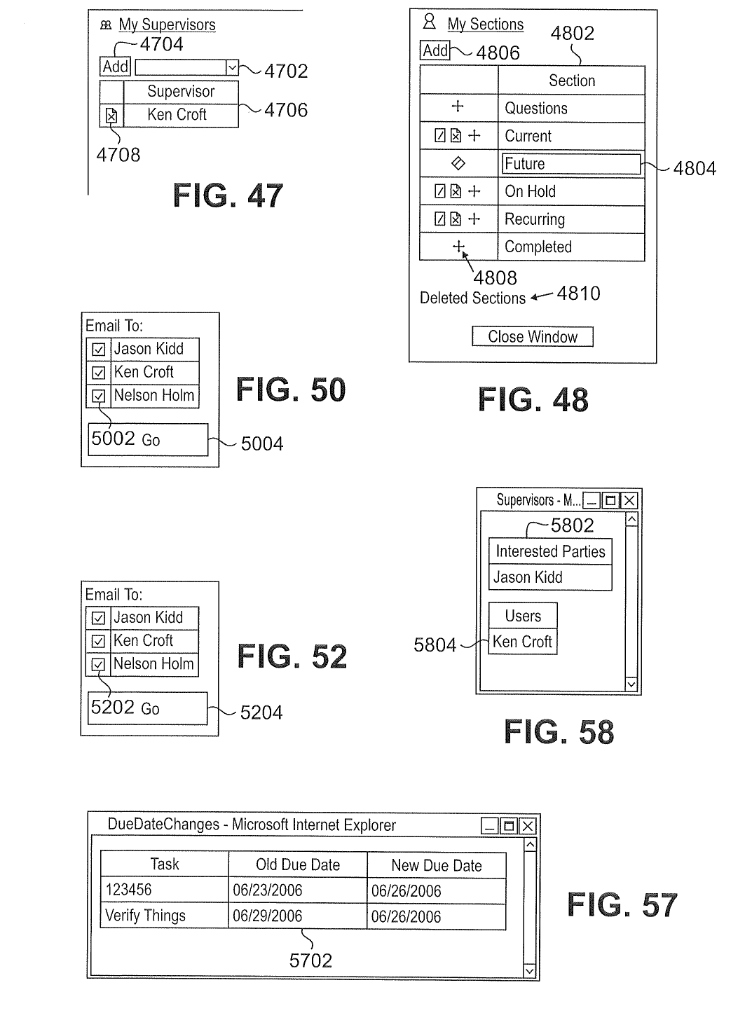

If the “Supervisors” button 3902 is selected by the user, the user may use the display shown in FIG. 47 to identify that user's supervisor(s). For example, the use could use a drop-down menu 4702 and an add button 4704 to add supervisors to a table 4706. The user can also use a delete button 4708 to remove supervisors from the table 4706. A supervisor is allowed to view the user's status reports in the supervisor's “My Inbox” tab 202 (which is described below). For example, the supervisor could view the user's status reports and make comments to any tasks in the user's status reports.

If the “My Sections” button 3902 is selected, the user can select which lists are displayed in the user's status report (such as lists 3908-3910) as shown in FIG. 48. In this example, a table 4802 identifies the sections currently included in a status report. An entry 4804 can be used to create a new section in the status report. The entry 4804 may be added to the table 4802 when the user selects an add button 4806. Various buttons 4808 allow the user to save a new entry 4804, delete or edit an existing entry, and move an entry within the table 4802 (thereby moving the corresponding section in the status report). If the user chooses to delete a section, the section can be listed in a deleted sections area 4810, and the user can later retrieve the deleted section and place it back in the table 4802. In some embodiments, certain sections (such as the “Completed” section) could always appear in a status report, and the user cannot delete these sections.

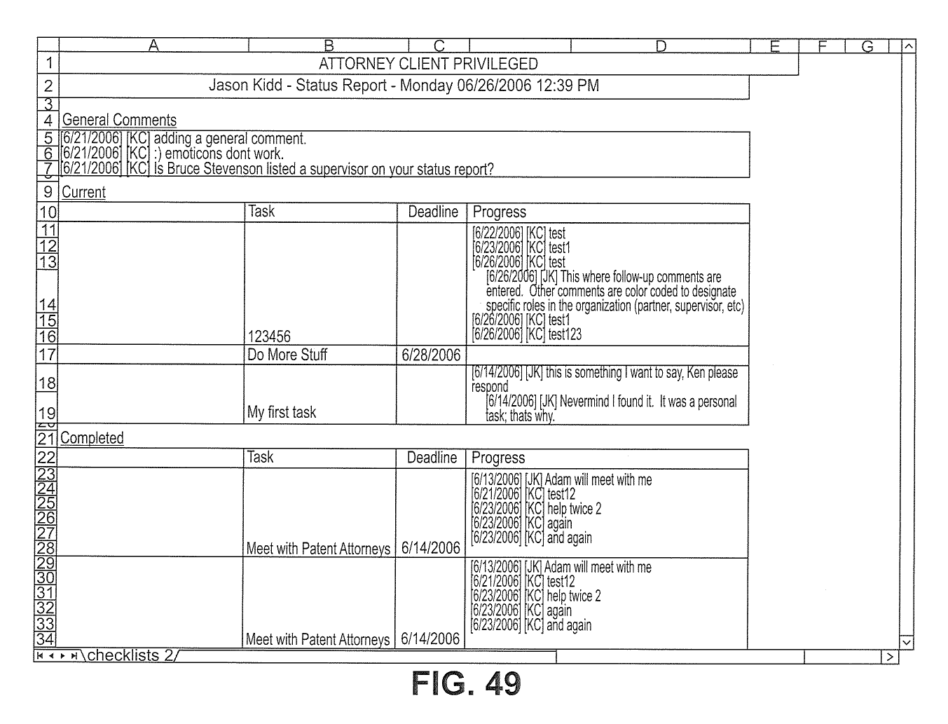

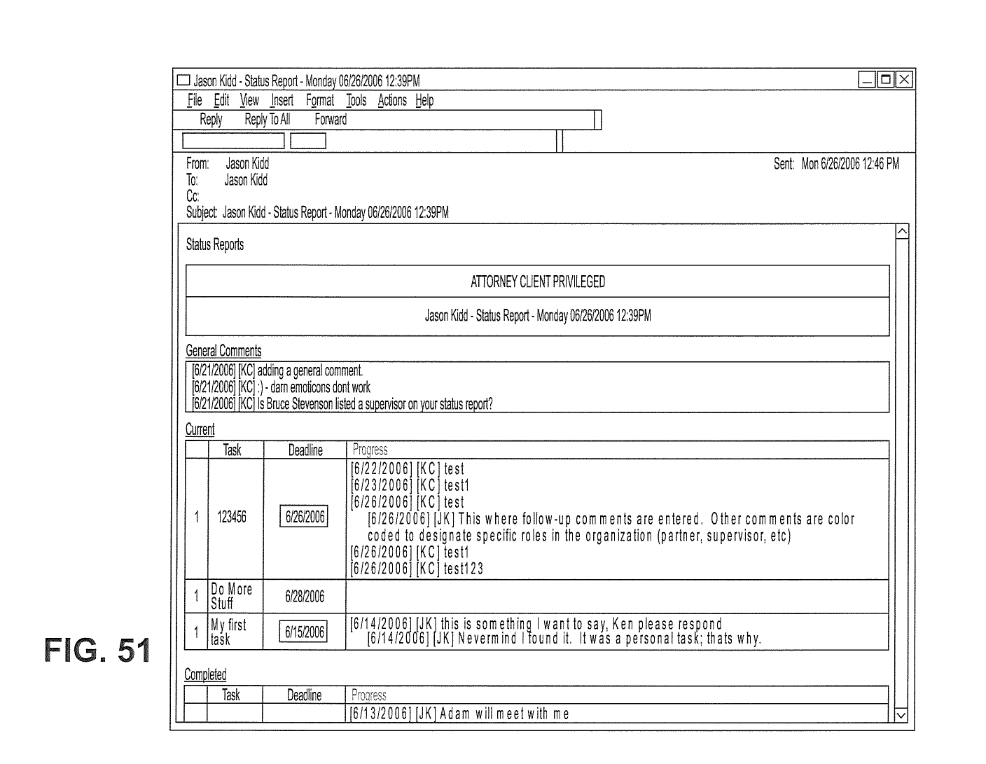

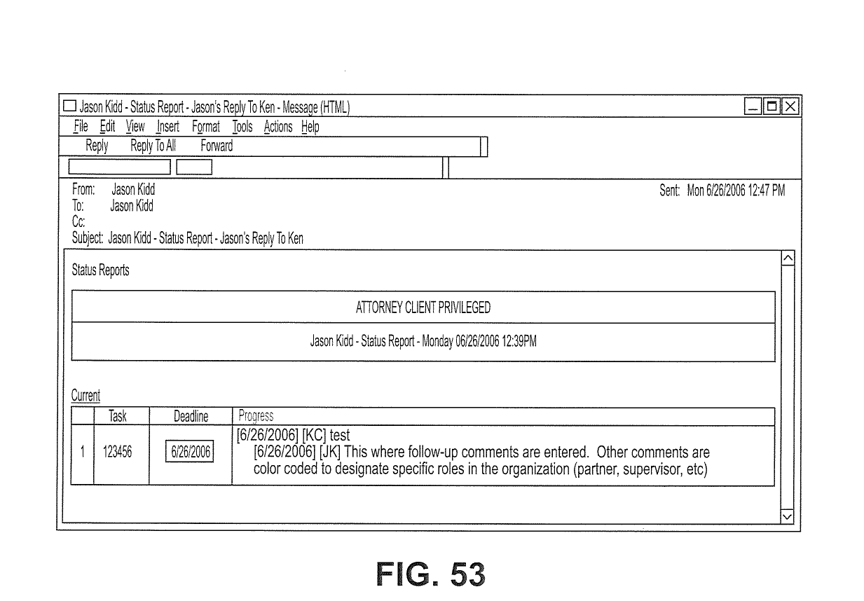

If the user selects the “Export” button 3902, the system 100 could generate a spreadsheet version of a status report, an example of which is shown in FIG. 49. Selection of the “Email” button 3902 presents the user with the display shown in FIG. 50, which allows the user to select different users using checkboxes 5002. A go button 5004 can be used to initiate transmission of an email containing a copy of the status report, which is sent to the selected users. An example email is shown in FIG. 51. Similarly, selection of the “Email Comments” button 3902 presents the user with the display shown in FIG. 52, which allows the user to select different users using checkboxes 5202. A go button 5204 can be used to initiate transmission of an email containing a copy of all comments in the status report. An example email containing comments is shown in FIG. 53. In some embodiments, the comments included in the email message in FIG. 53 could represent all comments occurring within a specified time period, such as the past hour. In this example, the users listed in FIGS. 50 and 52 could represent all owners of the current status report being viewed and all supervisors of the current user.

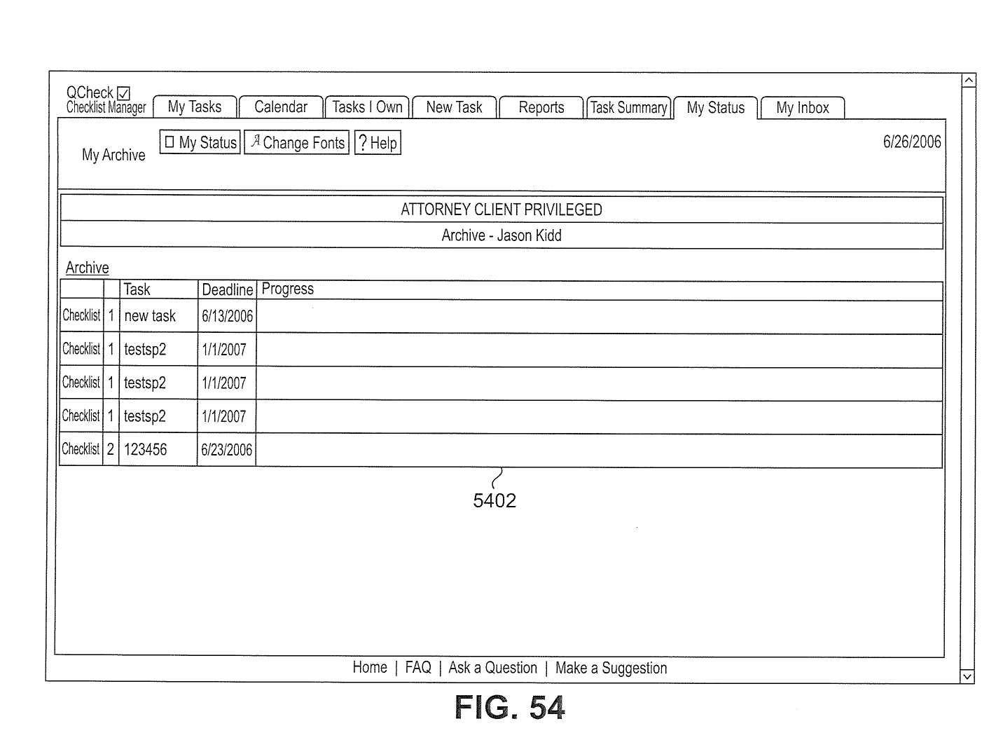

If the user selects the “View Archive” button 3902, the user could view the display shown in FIG. 54. This presents the user with a list 5402 of completed tasks associated with the user. In some embodiments, tasks are not deleted from the system 100 and are archived manually or automatically (such as after a specified period of time has elapsed since task completion). If the user selects the “Change Fonts” button 3902, the user is allowed to change the font of the current status report. If the user selects the “Help” button 3902, the user can be linked to an online help application or tool.

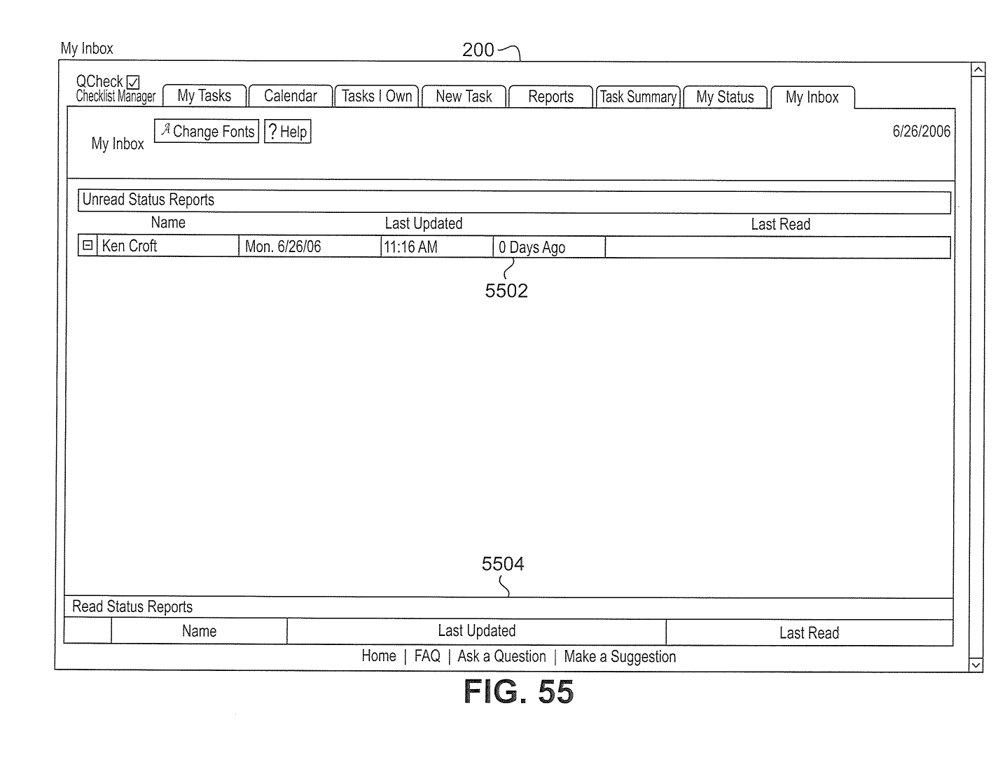

Selection of the “My Inbox” tab 202 displays the information in the graphical user interface 200 that is shown in FIG. 55. In FIG. 55, the graphical user interface 200 includes an unread report inbox 5502 and a read report inbox 5504. The unread report inbox 5502 identifies any unread status reports sent to the user, and the read report inbox 5504 identifies any read status reports sent to the user. If a status report has been read by the user, it is moved from the unread report inbox 5502 to the read report inbox 5504, where it remains until any new comments are added to the status report. When this occurs, the status report can be moved back into the unread report inbox 5502.

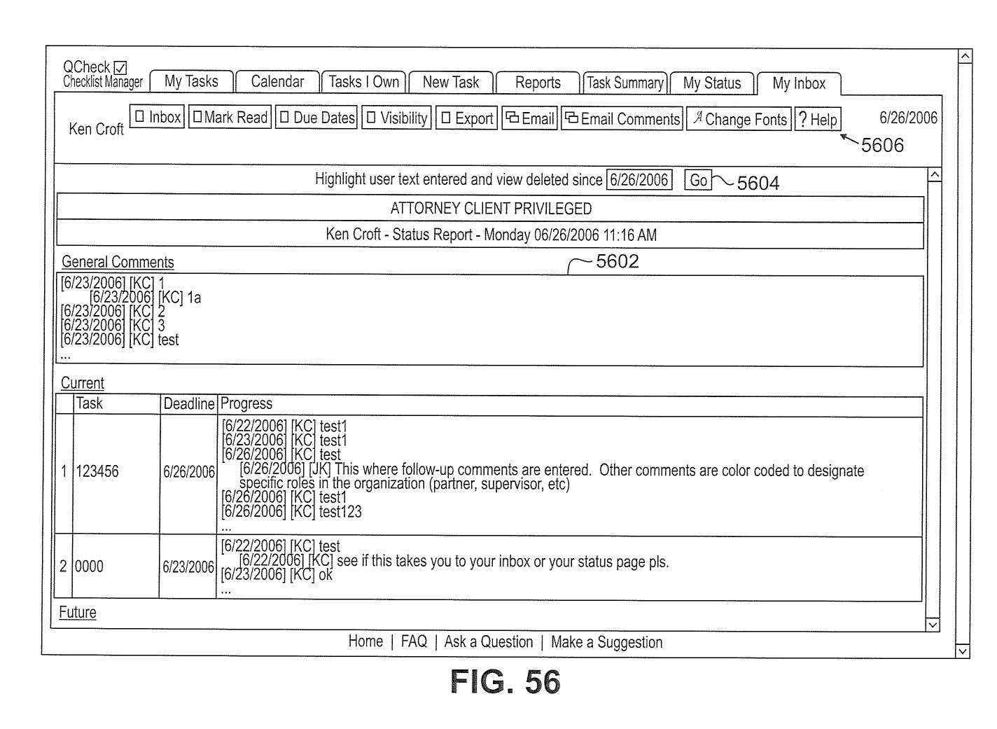

If the user selects any status report listed in the unread report inbox 5502 or the read report inbox 5504, the user can view the status report as shown in FIG. 56. Here, the status report contains a comments section 5602, which lists all of the comments in the associated status report. The comments are divided into general comments, comments related to current tasks, and comments related to future tasks. The user could use the displayed status report to add his or her comments, which are added in the appropriate locations in the status report and provided to other users. Also, a search mechanism 5604 is provided to allow the user to search for modifications made to the comments since a specified date. In addition, various buttons 5606 provide various functions related to the displayed status report.

If the user selects the “Inbox” button 5606 while viewing a report as shown in FIG. 56, the user may return to the display shown in FIG. 55. If the user selects the “Mark Read” button 5606, the status report that the user is viewing is moved into the read report inbox 5504 (at least until new comments are made to the status report).

If the user selects the “Due Dates” button 5606, the user may receive the display shown in FIG. 57, which includes a table 5702. The table 5702 identifies any tasks that have recently been assigned new due dates. The table 5702 could, for example, identify any tasks that have had their due dates changed within the last day or since the user last viewed the status report.

If the user selects the “Visibility” button 5606, the user may receive the display shown in FIG. 58, which includes two lists 5802-5804. The lists 5802-5804 identify users who are able to view the selected status report. The interested parties list 5802 could, for example, identify any supervisors or other users who are not listed as owners for the status report. The users list 5804 could identify any users who are listed as owners for the status report.

If the user selects the “Export” button 5606, the user could export a status report to a spreadsheet (such as is shown in FIG. 49). If the user selects the “Email” button 5606, the user could email a status report to other users (such as is shown in FIGS. 50 and 51). If the user selects the “Email Comments” button 5606, the user could email the comments from a status report to other users (such as is shown in FIGS. 52 and 53). If the user selects the “Change Fonts” button 5606, the user is allowed to change the font of the current status report. If the user selects the “Help” button 5606, the user can be linked to an online help application or tool.

The preceding description and related figures have described a particular graphical user interface 200 that can be used for task and process management. This represents only one of many possible implementations of the graphical user interface 200. Various details shown in FIGS. 2 through 58 and described above are for illustration and explanation only. Other embodiments of the graphical user interface 200 could also be used. For example, the content and the arrangement of the content in FIGS. 2 through 58 are for illustration only. Other graphical user interfaces could use any other or additional content arranged in any suitable manner. As a particular example, various features (such as the identification of a user's supervisor in a status report or a default alert sent to a user's supervisor) could be omitted. As another example, a user's ability to access and modify various information shown in FIGS. 2 through 58 may be restricted based on the user's access privileges or other security requirements. Further, while the use of various input, output, and navigation mechanisms (such as drop-down menus, free-form text boxes, buttons, and links) have been described, any other or additional techniques could be used to obtain information from a user, provide information to a user, or navigate within the graphical user interface. In addition, any other or additional aspects of a task or process can be managed using the graphical user interface.

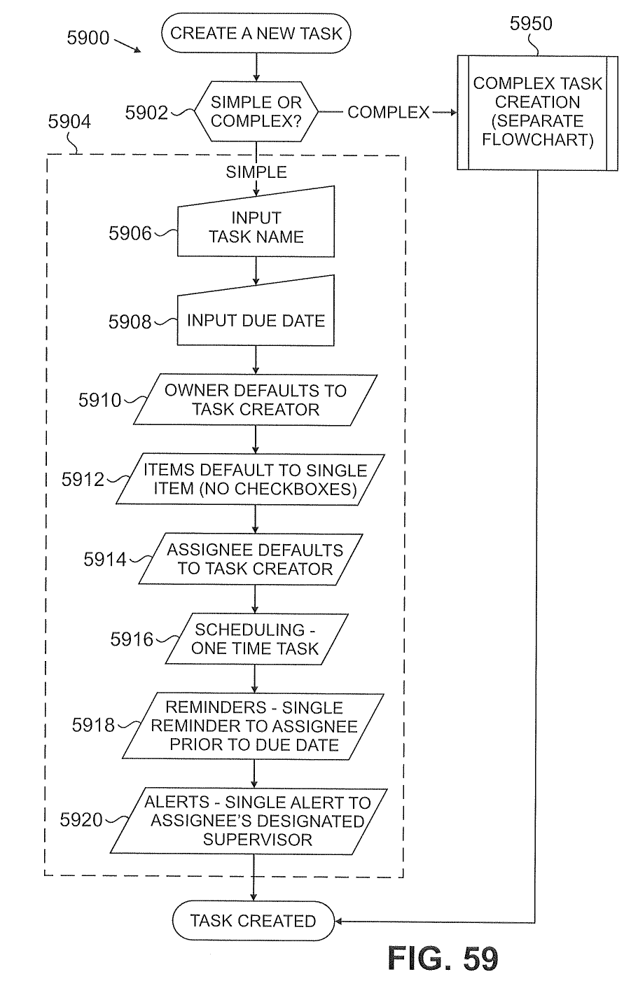

FIGS. 59 through 63 illustrate example methods for task and process management in accordance with this disclosure. The embodiments of the methods shown in FIGS. 59 through 63 are for illustration only. Other embodiments of the methods may be used without departing from the scope of this disclosure. Also, for ease of explanation, the methods shown in FIGS. 59 through 63 are described with respect to the task/process management server 106 in the system 100 of FIG. 1. The methods of FIGS. 59 through 63 could be used by any other suitable device and in any other suitable system.

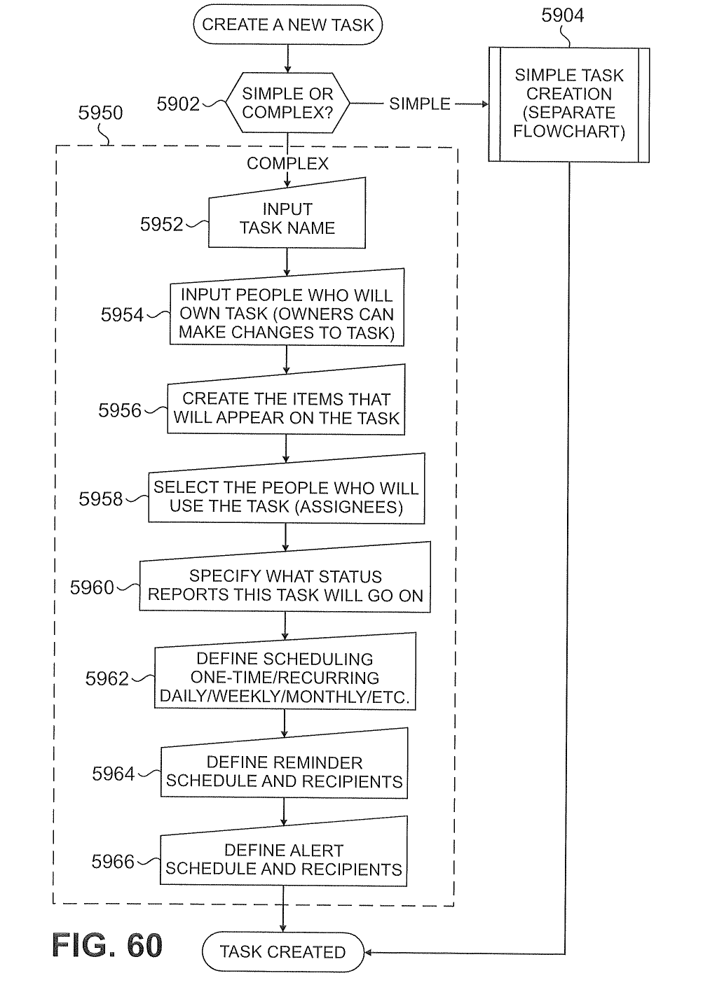

FIGS. 59 and 60 illustrate an example method 5900 for creating a new task. In FIG. 59, the task/process management server 106 receives a request to create a new task and determines if the new task is a simple or complex task at step 5902. This could include, for example, the task/process management server 106 using the menu 2402 in FIG. 24 to allow the user to identify whether a new task is a simple or complex task.

If the new task is a simple task, the task/process management server 106 creates the new simple task during process 5904. Otherwise, if the new task is a complex task, the task/process management server 106 creates the new complex task during process 5950 (shown in FIG. 60). During process 5904, the user inputs a task name to the task/process management server 106 at step 5906. The user also inputs a due date to the task/process management server 106 at step 5908. This could include, for example, the task/process management server 106 receiving this data via the display shown in FIG. 25.

Default values for the remaining task fields are then identified at steps 5910-5920. The owner of the task defaults to the current user creating the task at step 5910. The items in the task default to a single header item with no checkboxes or a single checkbox at step 5912. The assignee of the new task defaults to the user creating the task at step 5914. The scheduling for the task defaults to a one-time only task at step 5916. The reminders for the task default to a single reminder sent to the user creating the task before the identified due date at step 5918. The alerts for the task default to a single alert sent to the supervisor of the user creating the task at step 5920, although in other embodiments no default alert could be defined. At this point, the new simple task has been created and can be placed into service, such as by storing the task information in the database 108, including the new task in various status reports, and sending reminders and alerts when necessary.

As shown in FIG. 60, during process 5950, a new complex task is created. The user inputs a task name to the task/process management server 106 at step 5952. The user identifies any other users who are owners of the new complex task at step 5954. The user creates items (such as headings, subheadings, and checklists) to appear in the new complex task at step 5956. The user selects any other users who are to perform or otherwise use the task at step 5958. The user specifies which status report(s) the task will appear on at step 5960. These steps may include the use of the displays shown in FIGS. 26 through 30.

The user identifies the scheduling for the new complex task at step 5962. This may include the use of the display shown in FIG. 31. Also, the contents of the display in FIG. 31 could vary depending on whether the new complex task is recurring and the period between occurrences. This could be similar to the contents of the displays shown in FIGS. 15 through 20.

The user defines any reminders to be sent for the new complex task at step 5964, and the user defines any alerts to be sent for the new complex task at step 5966. These steps may include the use of the displays shown in FIGS. 32 and 33. At this point, the new complex task has been created and can be placed into service.

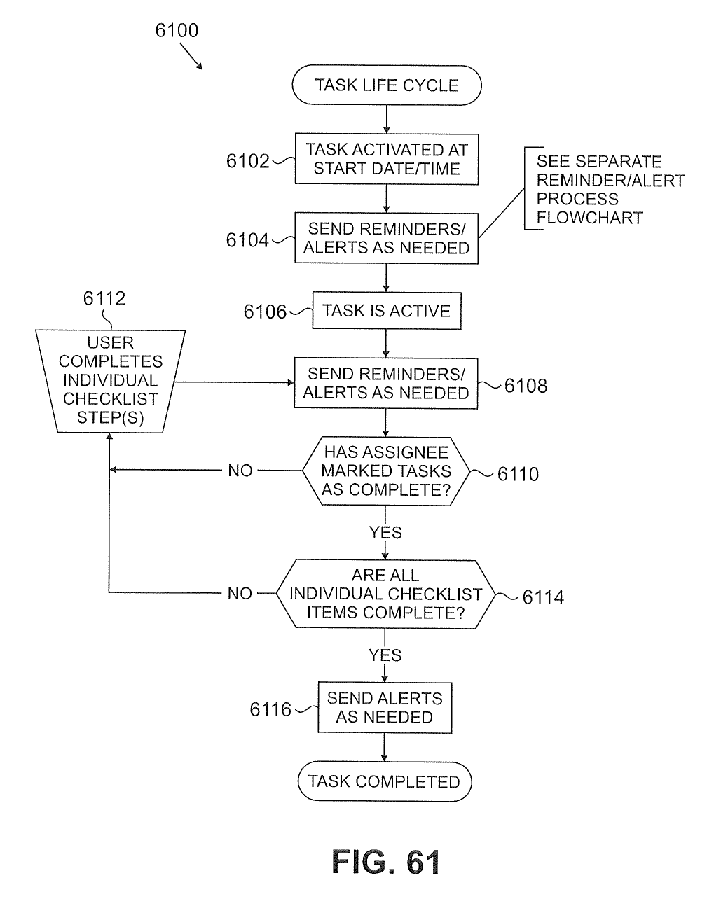

FIG. 61 illustrates an example method for supporting task completion. The task/process management server 106 activates a task at the task's specified start date and time at step 6102. This may include, for example, the task/process management server 106 listing the task as a “current” task (instead of a “future” task) for the appropriate user or users. The task/process management server 106 sends the appropriate reminders and alerts at step 6104, such as by sending a reminder or alert indicating the task has been activated. The task is then active at step 6106, during which time users can complete individual steps of the task. The task/process management server 106 sends additional reminders and alerts as needed at step 6108, such as by sending a reminder or alert indicating a step of the task needs to be completed.

The task/process management server 106 determines if an individual step in the task has been marked as complete at step 6110. If not, the task/process management server 106 waits for the appropriate user(s) to complete the individual task step at step 6112 and sends any necessary reminders or alerts at step 6108. The task/process management server 106 also determines if all individual steps in the task have been completed at step 6114. If not, the task/process management server 106 waits for the appropriate user(s) to complete the task steps at step 6112 and sends any necessary reminders or alerts at step 6108.

After all steps in the task have been completed, the task/process management server 106 sends any additional alerts at step 6116, such as an alert that the entire task has been completed. At this point, the task has been completed, which causes the task to be moved from any user's “current” task list to his or her “completed” task list.

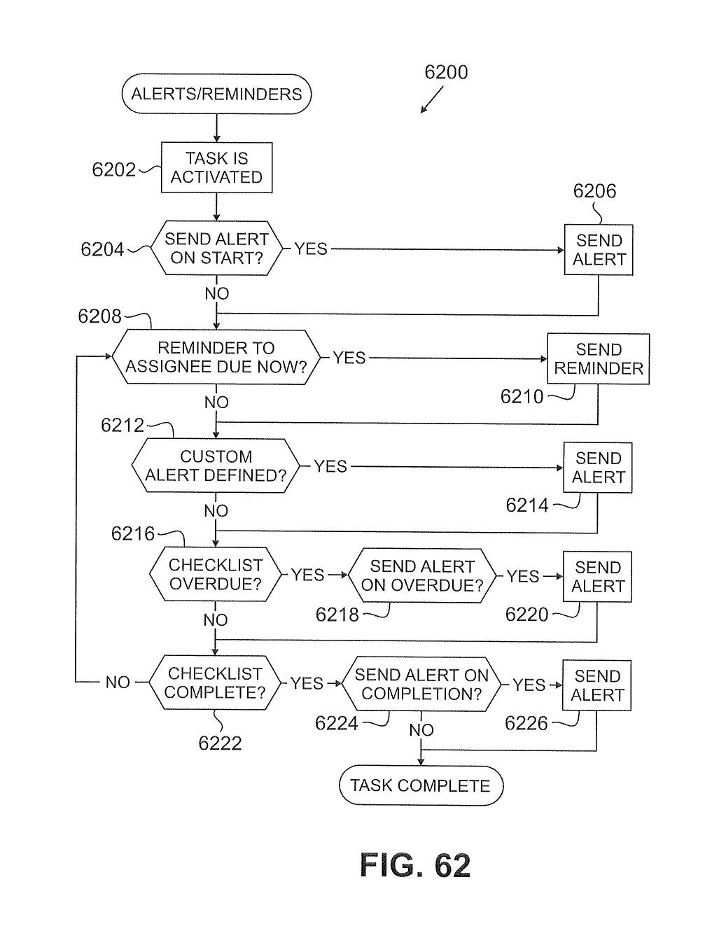

FIG. 62 illustrates an example method 6200 for generating reminders and alerts. The method 6200 shown in FIG. 62 could, for example, occur during the method 6100 of FIG. 61. A task is activated at step 6202, such as when the task's start date and time are reached. The task/process management server 106 determines if an alert is configured to be sent upon the start of the task at step 6204, and if so the alert is sent at step 6206.

The task/process management server 106 determines if any reminder is due at the current date and time at step 6208, and if so the reminder is sent at step 6210. The task/process management server 106 also determines if any custom alert is defined and due at step 6212, and if so the alert is sent at step 6214. The task/process management server 106 determines if any step in the task is overdue at step 6216 and if an overdue alert is configured to be sent at step 6218. If both are true, the task/process management server 106 sends an overdue alert at step 6220. The task/process management server 106 determines if the checklist for the task is complete at step 6222 and if a completion alert has been configured to be sent at step 6224. If so, the task/process management server 106 sends a task completion alert at step 6226. At this point, the task is complete, and no additional reminders or alerts need to be sent.

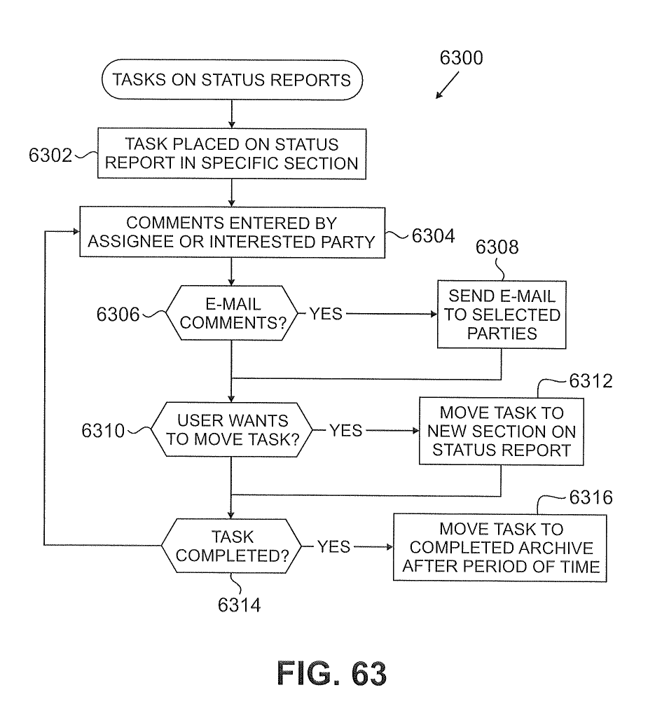

FIG. 63 illustrates an example method 6300 for handling tasks within a status report. The task/process management server 106 places a task in a specific section of a specific status report at step 6302. The user could have previously identified the status report and section, such as is shown in FIG. 30. Also, one or more comments about the task are entered by users at step 6304, and the comments are added to the status report. The task/process management server 106 determines if the comments need to be sent to any other users at step 6306, and if so the status report is emailed to the selected users at step 6308. The task/process management server 106 also determines if a user wishes to move a task within the status report, such as by moving a current task to the completed section of the report. If so (and the appropriate conditions are met), the task/process management server 106 moves the task within the status report at step 6312. The task/process management server 106 determines if the task has been completed at step 6314. If not, the task/process management server 106 returns to step 6304 to allow additional comments about the task to be entered. Otherwise, the task can be automatically moved to the completed section of the status report, and the task can be archived (and removed from the completed section) after a specified period of time has elapsed.

The preceding description and related figures have described particular methods that could be used by the task/process management server 106 for managing tasks and processes. This represents particular embodiments of the various methods. Details shown in FIGS. 59 through 63 and described above are for illustration and explanation only. The task/process management server 106 could operate in any other or additional manner. Also, while shown as a series of steps, each method in FIGS. 59 through 63 could operate in any other manner, such as when the steps occur in parallel or in a different order.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus, comprising:
at least one memory operable to store information identifying multiple steps associated with a task; and
at least one processor operable to:
receive first input from one or more users indicating completion of at least one of: the task and each step associated with the task;
receive second input comprising a dialog between multiple ones of the users; and
generate a graphical display for presentation to the one or more users, the graphical display identifying at least some of the steps associated with the task, a status of at least one of: the task and at least some of the steps associated with the task, and at least a portion of the dialog between the multiple users.

2. The apparatus of claim 1, wherein the dialog comprises:
at least one comment associated with at least one of: the task and at least one of the steps associated with the task; and
at least one response to the at least one comment.

3. The apparatus of claim 1, wherein the graphical display identifies multiple tasks classified into different categories, each task associated with an input mechanism operable to be selected to present a list of the steps associated with that task.

4. The apparatus of claim 1, wherein the at least one processor is further operable to allow at least one of the users to associate the task with a status report, the status report containing the dialog between the multiple users.

5. The apparatus of claim 4, wherein the at least one processor is further operable to allow at least one of the users to specify which users are allowed to view and modify the status report.

6. The apparatus of claim 4, wherein the at least one processor is further operable to allow at least one of the users to email the status report to at least one other of the users.

7. The apparatus of claim 4, wherein the at least one processor is further operable to allow at least one of the users to specify that the status report is subject to a confidentiality obligation.

8. The apparatus of claim 1, wherein the at least one processor is further operable to allow at least one of the users to assign the task to at least one other of the users.

9. The apparatus of claim 1, wherein the graphical display generated for presentation to a specific one of the users comprises:
a list of tasks each having at least one step to be completed by the user;
a calendar identifying the tasks associated with the user for a selected day or week;
a list of tasks that the user has authority to modify; and
a report identifying the tasks associated with the user.

10. The apparatus of claim 1, wherein the at least one processor is further operable to allow at least one of the users to define the task, wherein definition of the task comprises definition of:
one or more reminders to be sent to one or more users who are assigned to complete the steps of the task; and
one or more alerts to be sent to one or more other users who are not assigned to complete the steps of the task.

11. A method, comprising:
receiving first input from one or more users indicating at least one of: completion of a task and completion of each of multiple steps associated with the task;
receiving second input comprising a dialog between multiple ones of the users; and
generating a graphical display for presentation to the one or more users, the graphical display identifying at least some of the steps associated with the task, a status of at least one of: the task and at least some of the steps associated with the task, and at least a portion of the dialog between the multiple users.

12. The method of claim 11, wherein the dialog comprises:
at least one comment associated with at least one of: the task and at least one of the steps associated with the task; and
at least one response to the at least one comment.

13. The method of claim 11, wherein the graphical display identifies multiple tasks classified into different categories, each task associated with an input mechanism operable to be selected to present a list of the steps associated with that task.

14. The method of claim 11, further comprising:
allowing at least one of the users to associate the task with a status report, the status report containing the dialog between the multiple users; and
allowing at least one of the users to specify which users are allowed to view and modify the status report.

15. The method of claim 14, further comprising identifying that the status report is subject to a confidentiality obligation.

16. The method of claim 11, wherein the graphical display generated for presentation to one of the users comprises:
a list of tasks each having at least one step to be completed by the user;
a calendar identifying the tasks associated with the user for a selected day or week;
a list of tasks that the user has authority to modify; and
a report identifying the tasks associated with the user.

17. A computer program embodied on a computer readable medium and operable to be executed by a processor, the computer program comprising:
computer readable program code for receiving first input from one or more users indicating at least one of: completion of a task and completion of each of multiple steps associated with the task;
computer readable program code for receiving second input comprising a dialog between multiple ones of the users; and
computer readable program code for generating a graphical display for presentation to the one or more users, the graphical display identifying at least some of the steps associated with the task, a status of at least one of: the task and at least some of the steps associated with the task, and at least a portion of the dialog between the multiple users.

18. The computer program of claim 17, wherein the dialog comprises:
at least one comment associated with at least one of: the task and at least one of the steps associated with the task; and
at least one response to the at least one comment.

19. The computer program of claim 17, wherein the graphical display identifies multiple tasks classified into different categories, each task associated with an input mechanism operable to be selected to present a list of the steps associated with the task.

20. The computer program of claim 17, further comprising:
computer readable program code for allowing at least one of the users to associate the task with a status report, the status report containing the dialog between the multiple users; and
computer readable program code for allowing at least one of the users to specify which users are allowed to view and modify the status report.

21. The computer program of claim 20, further comprising computer readable program code for identifying that the status report is subject to a confidentiality obligation.

22. A system, comprising:
a database operable to store information identifying multiple steps associated with a task;
a server operable to:
receive first input from one or more users indicating completion of at least one of: the task and each step associated with the task;
receive second input comprising a dialog between multiple ones of the users; and
generate a graphical display for presentation to the one or more users, the graphical display identifying at least some of the steps associated with the task, a status of at least one of: the task and at least some of the steps associated with the task, and at least a portion of the dialog between the multiple users; and
at least one user device operable to display the graphical display and provide the first and second inputs from the one or more users to the server.
